(19) United States
(12) Patent Application Publication
(10) Pub. No.: US 2026/0289859 A1
(43) Pub. Date: Sep. 24, 2026

(54) SYSTEM

(71) Applicant: SoftBank Group Corp., Tokyo (JP)

(72) Inventor: Shiho ONO, Tokyo (JP)

(73) Assignee: SoftBank Group Corp., Tokyo (JP)

(21) Appl. No.: 19/567,353

(22) Filed: Mar. 16, 2026

(30) Foreign Application Priority Data
Mar. 19, 2025 (JP) 2025-045130

(51) Int. Cl. G06T 11/60; G06F 40/211; G06N 3/0475; H04L 51/02

(52) U.S. Cl. CPC G06T 11/60; G06F 40/211; G06N 3/0475; H04L 51/02

(57) ABSTRACT

A system includes a processor that is configured to receive text data as input from a user and analyze the text data using a natural language processing technique to extract at least one emotion and at least one visual element, generate, based on the extracted emotion and the extracted visual element, a prompt for instructing a generative artificial intelligence model to generate a visual representation, and control an output device to provide the generated visual representation as at least one of a physical poster and a digital art work.

### CROSS-REFERENCE TO RELATED APPLICATION

This application is based on and claims priority under 35 USC 119 from Japanese Patent Application No. 2025-045130 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for generating images from text inputs are generally designed to convert descriptive text into visual content without deeply considering the user's subjective emotional nuances or personal nostalgic impressions. As a result, even when a user describes a meaningful memory or emotionally significant scene, the generated visual representation often fails to reflect the user's emotional state, the intensity of that emotion, or the specific visual elements that are important to the user. Furthermore, existing systems typically do not provide an integrated mechanism for transforming such generated visual representations into various tangible or digital formats, such as physical posters, digital artworks, smartphone wallpapers, or booklets, in a manner that preserves the emotional characteristics of the original memory. Therefore, there is a need for a system that can analyze user-provided text, accurately extract emotional and visual elements, generate prompts suitable for a generative artificial intelligence model based on those elements, and provide the resulting visual representations in multiple output formats while reflecting the user's emotional nuances.

### SUMMARY

To solve the above problem, the present invention provides a system comprising a processor, wherein the processor is configured to receive text data as input from a user and analyze the text data using a natural language processing technique to extract at least one emotion and at least one visual element. The processor is further configured to generate, based on the extracted emotion and the extracted visual element, a prompt for instructing a generative artificial intelligence model to generate a visual representation, and to control an output device to provide the generated visual representation as at least one of a physical poster and a digital art work. In addition, the processor is configured to convert the generated visual representation into an appropriate format for providing the generated visual representation as at least one of a smartphone wallpaper and a booklet. Moreover, the processor is configured to identify an intensity and a type of the emotion by using an emotion analysis algorithm to understand an emotional nuance of the user and to reflect the emotion in the visual representation. By performing these operations, the system enables generation and provision of visual representations that closely reflect the user's emotional state and nostalgic impressions in diverse physical and digital formats.

The term “text data” refers to character-based information input by a user, including but not limited to sentences, phrases, or descriptions expressing memories, scenes, or emotions, which is suitable for processing by natural language processing techniques.

The term “natural language processing technique” refers to any computational method or algorithm that analyzes human language, including but not limited to tokenization, part-of-speech tagging, syntactic parsing, semantic analysis, entity recognition, and sentiment or emotion detection.

The term “emotion” refers to an affective state inferred from the text data, including but not limited to feelings such as happiness, nostalgia, sadness, excitement, calmness, or anxiety, which can be represented by type and optionally intensity.

The term “visual element” refers to a component of an image or scene that can be visually represented, including but not limited to objects, backgrounds, colors, lighting conditions, weather, time of day, and spatial arrangements, derived from analysis of the text data.

The term “prompt” refers to a structured text instruction or input formed by the processor and provided to a generative artificial intelligence model, the prompt specifying at least one emotion and at least one visual element to guide the generation of a visual representation.

The term “generative artificial intelligence model” refers to a machine learning model configured to generate new content, including but not limited to images or illustrations, based on input such as prompts, and including, for example, diffusion models, generative adversarial networks, and transformer-based generative models.

The term “visual representation” refers to an image, illustration, or other graphical output generated by the generative artificial intelligence model based on the prompt, which visually expresses at least one emotion and at least one visual element extracted from the text data.

The term “output device” refers to any hardware or combination of hardware configured to present or deliver the visual representation to the user, including but not limited to printers, display devices, and interfaces for transmitting digital files to external services or client devices.

The term “physical poster” refers to a tangible printed medium on which the visual representation is printed in a size and resolution suitable for wall display or similar usage.

The term “digital art work” refers to an electronic file containing the visual representation in a digital image format, suitable for display on electronic devices or for further digital processing, sharing, or storage.

The term “smartphone wallpaper” refers to a digital image file derived from the visual representation and formatted or resized for use as a background image on a smartphone or similar mobile terminal.

The term “booklet” refers to a collection of one or more pages, in physical or digital form, in which the visual representation is arranged, optionally together with text data or additional information, and which is suitable for viewing as a compiled memory or art collection.

The term “emotion analysis algorithm” refers to a software-implemented procedure or model that analyzes text data to determine at least one type of emotion and optionally an intensity or degree of the emotion, for use in influencing or controlling the generated visual representation.

The term “intensity of the emotion” refers to a quantitative or qualitative measure of the strength or degree of an identified emotion, such as weak, moderate, or strong, or a corresponding numerical score or level.

The term “type of the emotion” refers to a categorical label assigned to an identified emotion, such as joy, nostalgia, sadness, fear, comfort, or excitement, derived from the analysis of the text data.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1 ;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

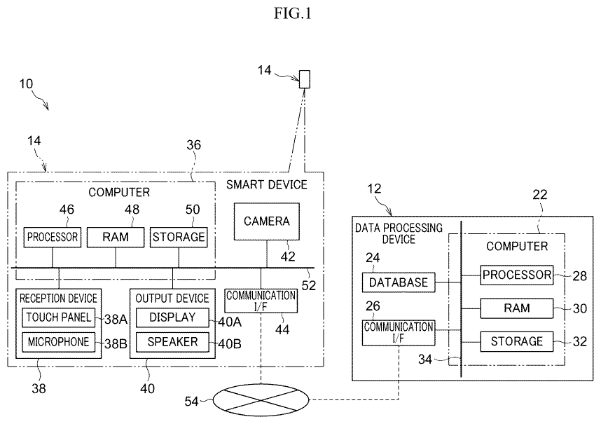

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

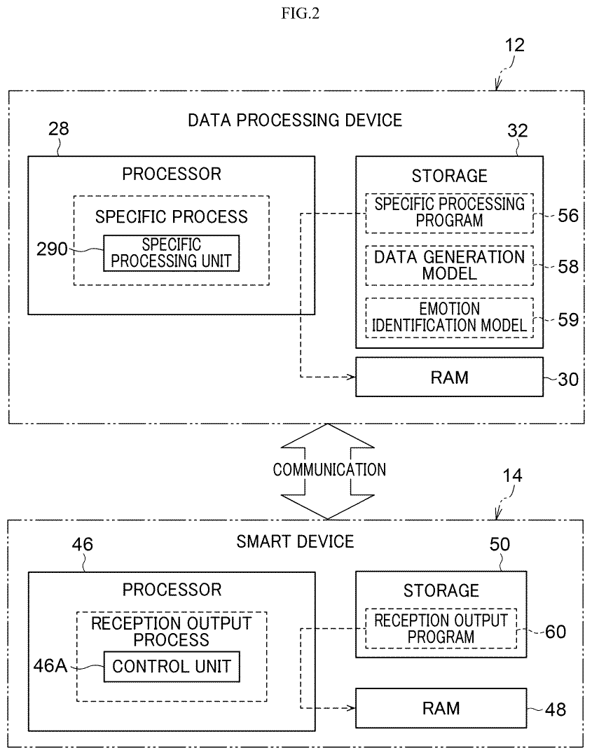

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional content generation systems that utilize machine learning models to produce text or images from user input suffer from several technical limitations in terms of data handling, model interaction, and output control at the system level. First, such systems typically accept free-form user input and forward it directly, or with only minimal filtering, to a generative model. As a result, the input text may contain noise, control characters, or ambiguities that negatively affect tokenization and model inference, leading to unstable latency, inefficient use of computational resources, and degraded output quality.

Second, existing systems generally perform text generation and image generation as separate, loosely coupled processes. For example, a generated text may be manually or heuristically repurposed as an image prompt, without a systematic pipeline that transforms preprocessed user text into an extended narrative and then into a structured image prompt. This lack of integration makes it difficult for the system to maintain semantic consistency between textual outputs and visual outputs, and requires additional manual intervention or ad hoc scripts, thereby increasing processing complexity and response time.

Third, many systems treat user emotion and visual nuance as implicit features, relying entirely on the internal behavior of the generative model. Without explicit extraction and numerical representation of emotion from the input text, the system cannot programmatically adjust prompts for text generation and image generation based on quantified emotional characteristics. This limits the ability of the system to systematically control the tone, intensity, and emotional nuance of the generated content, and can lead to outputs that do not match the user's intended affective state.

Fourth, conventional architectures often lack an integrated mechanism to store, associate, and reuse intermediate artifacts, such as preprocessed text, extended text, and visual expression data. Without a structured storage design that links these artifacts, the system cannot efficiently support re-generation, iterative refinement, or downstream processing, and is forced to recompute similar content repeatedly. This increases network traffic to external model services, consumes additional computational resources, and can result in inconsistent outputs across sessions.

Accordingly, there is a need for a technical solution that improves the overall computer system behavior by: (i) performing structured preprocessing of user-provided text to obtain clean, model-ready representations; (ii) extracting emotion and visual elements and generating structured prompt sentences tailored for a generative AI model; (iii) orchestrating a coordinated pipeline that produces extended text and, based on that text, generates visual expression data via an image generation model; (iv) quantifying emotional information and using it to automatically adjust prompt sentences for both textual and visual generation; and (v) storing and managing the related data elements in association with each other for efficient reuse and regeneration. Such a solution should enhance reliability, controllability, and efficiency of the end-to-end generative process at the server side, thereby improving the underlying computer technology rather than merely presenting an abstract idea.

The specific processing by the specific processing unit 290 of the data processing device 12 in Example 1 is realized by the following means.

The present invention provides a server comprising a processor configured to receive, from a terminal operated by a user, text data including a prompt sentence that expresses a memory or an emotion of the user, the text data being transmitted as character information via a communication network, to execute natural language processing on the text data to perform preprocessing including tokenizing the text data and removing unnecessary characters to obtain preprocessed text data, to analyze the preprocessed text data to extract at least an emotion element and a visual element, to generate, on the basis of the preprocessed text data, a generation instruction sentence including a prompt sentence for input to a generative artificial intelligence model, to transmit, via a communication interface, generation request data including the prompt sentence to the generative artificial intelligence model, to acquire, from the generative artificial intelligence model, extended text that describes in detail the memory or the emotion of the user corresponding to the prompt sentence, to generate, on the basis of the extended text, an image generation prompt sentence and to transmit the image generation prompt sentence to an image generation model, to acquire visual expression data generated by the image generation model and to convert the extended text and the visual expression data into output data in an output data format, and to store, in a storage device, at least part of the text data, the preprocessed text data, the extended text, and the visual expression data in association with one another for reuse or regeneration. This enables the server to implement a technically integrated pipeline that cleans and structures user input for model consumption, programmatically extracts and quantifies emotion and visual elements, coordinates text generation and image generation through structured prompt sentences, maintains semantic and emotional consistency across textual and visual outputs, and persistently manages related data artifacts for efficient recomputation and iterative refinement, thereby improving the performance, reliability, and controllability of computer-based generative content processing.

The term “system” refers to an arrangement of one or more hardware devices and software components that cooperate to execute the processing described in the claims, including at least a server, a storage device, a communication interface, and one or more terminals.

The term “server” refers to an information processing apparatus including at least one processor, a memory, and a communication interface, the information processing apparatus being configured to execute programs that implement receiving, preprocessing, analyzing, generating, transmitting, and storing operations on data as described in the claims.

The term “processor” refers to one or more hardware processing units, such as a central processing unit or a graphics processing unit, and associated execution circuitry, configured to execute instructions of one or more software programs to perform the functions recited in the claims.

The term “terminal” refers to an end-user device capable of inputting, transmitting, receiving, and displaying data, such as a portable information device, a smartphone, a tablet device, a personal computer, or an equivalent user-operated computing device.

The term “user” refers to a human operator or an entity that interacts with the system by providing input data and receiving output data through the terminal.

The term “text data” refers to digital data representing a sequence of characters, symbols, or words, including but not limited to natural language sentences, that are processed by the server according to the methods described in the claims.

The term “prompt sentence” refers to a portion of the text data, typically expressed as natural language, that is intended to guide or condition the behavior of a generative artificial intelligence model or an image generation model.

The term “character information” refers to encoded representations of characters, such as letters, numbers, and symbols, in a predetermined character encoding format that can be transmitted, stored, and processed by the system.

The term “communication network” refers to any wired or wireless data network, such as a local area network, a wide area network, or the Internet, that enables data communication between the terminal, the server, and external services.

The term “natural language processing” refers to a class of computational techniques and algorithms executed by the processor to analyze, transform, or understand human language text, including operations such as tokenization, part-of-speech tagging, parsing, normalization, and related text processing.

The term “preprocessing” refers to a series of computational operations applied to the text data prior to input to a generative artificial intelligence model or an image generation model, the operations including at least tokenizing the text data and removing unnecessary characters to obtain preprocessed text data.

The term “tokenizing” refers to an operation that segments the text data into smaller units, such as words, subwords, or symbols, which are suitable for subsequent analysis or for input to a machine learning model.

The term “unnecessary characters” refers to characters or symbols in the text data that are not required for semantic interpretation or model processing, such as control characters, redundant whitespace, or unsupported symbols, which are removed during preprocessing.

The term “preprocessed text data” refers to text data that has been subjected to preprocessing operations, including tokenization and removal of unnecessary characters, and that is in a format suitable for subsequent analysis and model input.

The term “emotion element” refers to information extracted from text data that represents a type, valence, or intensity of a psychological or affective state, such as happiness, sadness, or nostalgia, which can be used to influence generated content.

The term “visual element” refers to information extracted from text data that represents spatial, color, object, or scene attributes describing a visual situation, which can be used to influence generation of an image or other visual representation.

The term “generation instruction sentence” refers to a structured natural language sentence or set of sentences generated by the server, containing instructions suitable for conditioning a generative artificial intelligence model to produce desired output content.

The term “generative artificial intelligence model” refers to a trained computational model, typically based on machine learning or deep learning architectures, that generates text, audio, or other data in response to input data such as a prompt sentence.

The term “generation request data” refers to data transmitted from the server to a generative artificial intelligence model, the data including at least a prompt sentence and optionally additional control parameters that specify conditions for generating output.

The term “extended text” refers to text generated by the generative artificial intelligence model in response to the generation request data, the text providing a more detailed or elaborated description of an input prompt sentence, including additional narrative, context, or sensory details.

The term “image generation prompt sentence” refers to a natural language sentence or structured text generated on the basis of the extended text, the sentence being formatted to condition an image generation model to create visual expression data.

The term “image generation model” refers to a computational model, typically a machine learning or deep learning model, configured to generate image data or visual content based on an input such as an image generation prompt sentence.

The term “visual expression data” refers to digital data representing visual content, such as raster image data, vector graphics data, or a structured description that can be rendered as an image, generated by the image generation model.

The term “output data” refers to data that combines at least the extended text and the visual expression data and that is formatted in a representation suitable for transmission to and display on a terminal or an output apparatus.

The term “output data format” refers to a data structure or encoding specification, such as a particular image file format, document format, or multimedia container format, in which the output data is organized for delivery and presentation.

The term “display device” refers to a hardware component, such as a liquid crystal display, an organic light-emitting diode display, or an equivalent visual output device, which is configured to present the extended text and the visual expression data to the user.

The term “storage device” refers to a non-transitory computer-readable medium, such as a magnetic disk, a solid-state drive, a non-volatile memory, or an equivalent storage resource, used to store text data, preprocessed text data, extended text, and visual expression data.

The term “reuse” refers to a process in which stored data, such as preprocessed text data, extended text, or visual expression data, is retrieved and employed again for further processing, regeneration, or modification without repeating all initial computation steps.

The term “regeneration” refers to a process in which new generated content is produced based on previously stored data, such as text data, extended text, or emotional information, optionally with modified parameters or additional prompts.

The term “portable information device” refers to a mobile computing device, such as a smartphone, a handheld terminal, or a tablet computer, that a user can carry and operate to send and receive data with the server.

The term “background image” refers to image data that is formatted and sized to be used as a backdrop or wallpaper on a display of a portable information device or another computing device.

The term “printed medium” refers to a physical substrate, such as paper, cardboard, or similar material, onto which an image is printed to produce a physical poster, booklet, or other tangible item.

The term “electronic publication” refers to a digital document, such as an electronic book, an electronic magazine, or a digital catalog, that is stored and displayed on an electronic device.

The term “digital content” refers to content represented in digital form, including at least images, text, audiovisual materials, and composite media, that can be stored, transmitted, and rendered by computing devices.

The term “emotion analysis processing” refers to a computational process that detects and quantifies emotional information in text data by classifying an emotion type and computing an emotion intensity or related numerical index.

The term “numerical index” refers to a numerical value or set of values generated during emotion analysis processing, representing characteristics such as the type, strength, or polarity of an emotion identified in the text data.

The term “emotional nuance” refers to subtle qualitative aspects of a user's emotional state, including variations in intensity, tone, or mood, which can be reflected in generated text or visual expression data through adjustment of prompt sentences and other parameters.

In one embodiment, a server cooperates with at least one terminal operated by a user to implement the claimed system. The server comprises at least one processor, a main memory, a non-volatile storage device, and a communication interface coupled via an internal bus. The terminal comprises a processor, a memory, a display device, an input interface such as a touch panel or keyboard, and a communication module configured for wired or wireless communication (for example, cellular, Wi-Fi, or Ethernet).

The user operates the terminal to launch an application or a web client. The terminal displays an input screen prompting the user to enter a prompt sentence that expresses a memory or an emotion. The user inputs a natural language sentence such as “the summer seaside scenery I spent as a child with my family” or “Describe my childhood summer seaside scenery with my family in a very detailed and emotional way.” The terminal converts the input into text data encoded in a character encoding format, such as UTF-8, and stores the text data in a buffer structure in memory.

The terminal transmits the text data to the server via the communication network using a request message. In one example, the terminal executes a client module implemented using a web framework or a native application framework and encapsulates the text data in a structured message body. The terminal associates the text data with metadata such as a user identifier, a language code, and a timestamp, and then sends the data through a transport protocol such as HTTPS.

The server receives the request message through the communication interface and stores the text data and the metadata in a request queue managed in main memory. The server uses an application framework, such as a general-purpose network server framework, to parse the message, extract the text data, and pass the extracted data to a natural language processing module. In one embodiment, the server uses a programming language runtime such as a Python runtime to execute the natural language processing module. The server loads one or more natural language processing libraries, such as a library including tokenization, part-of-speech tagging, and sentence segmentation functions (for example, libraries analogous to NLTK or spaCy), into memory.

The server applies preprocessing to the text data to obtain preprocessed text data. The server performs tokenization by applying a tokenizer function that splits the text into a sequence of tokens, each represented as a string in a token array or list. The server removes unnecessary characters by applying pattern-based filters and normalization rules to each token and to the overall character sequence. For example, the server removes control characters, redundant whitespace, and unsupported symbols and may normalize punctuation and character width.

The server optionally applies additional natural language processing operations, such as lowercasing, stopword filtering, and lemmatization. The server stores the resulting preprocessed text data in an internal data structure, such as a normalized text string coupled with a token list and associated annotations.

The server analyzes the preprocessed text data to extract at least one emotion element and at least one visual element. In one embodiment, the server executes an emotion analysis module that uses a feature extraction algorithm to convert the token sequence into a feature vector.

The server may compute features such as token frequency counts, n-gram statistics, sentiment lexicon matches, and context embeddings. The server then feeds the feature vector into an emotion classifier, which may be implemented as a neural network, such as a feed-forward network or a recurrent network, or as another machine learning classifier. The emotion classifier outputs a probability distribution over predefined emotion categories (for example, happiness, sadness, nostalgia, excitement) and a continuous score for intensity. The server converts this probability distribution and intensity into a numerical index representing the type and strength of the emotion element.

The server extracts the visual element by executing a visual concept extraction module that identifies terms and phrases associated with scenes, objects, colors, and spatial relationships.

In one embodiment, the server uses a syntactic parser implemented by a natural language processing library to obtain a dependency tree or parse tree. The server traverses the tree to detect noun phrases, adjectives, and prepositional phrases indicating scene attributes such as “seaside,” “sunset,” “blue sky,” “waves,” and “family.” The server stores the extracted visual elements in a structured representation, such as a dictionary or graph indicating entities, attributes, and relations.

The server generates a generation instruction sentence including a prompt sentence for input to a generative AI model. In one embodiment, the server combines the preprocessed text data, the numerical index representing emotion, and the structured visual elements into a formatted prompt. The server uses template rules and conditional logic to generate text such as “Generate a detailed, emotionally rich description of the following memory, emphasizing the feeling of nostalgia and the visual elements of a summer seaside with gentle waves, warm sand, and family members.” The server thus produces a prompt sentence that is more structured and information-dense than the original user input, which improves the behavior of the downstream model.

The server transmits generation request data including the prompt sentence to a generative AI model. The generative AI model can be deployed on the same server or on a remote computation environment connected through a network. In one embodiment, the generative AI model is implemented as a transformer-based neural network comprising multiple self-attention layers, feed-forward layers, and layer normalization blocks. The model is trained using a large corpus of text and a language modeling objective. During training, the model updates weight matrices by minimizing a loss function, such as cross-entropy between predicted token distributions and target tokens, using an optimization algorithm such as stochastic gradient descent or an adaptive method. The model uses positional encodings, multi-head attention, and large parameter matrices to represent contextual relationships between tokens.

During inference, the server converts the prompt sentence into token identifiers using a tokenizer associated with the generative AI model, and sends the token identifiers and model parameters (such as maximum output length, temperature, and sampling strategy) to the model. The model performs a sequence of matrix multiplication operations and non-linear transformations for each layer to compute, for each time step, a probability distribution over the vocabulary. The model selects or samples the next token based on this distribution and iteratively generates a token sequence that constitutes extended text. The server receives the extended text from the model as a sequence of token identifiers and decodes the identifiers into characters to obtain a natural language sentence string. The extended text, for example, may be “Under the bright blue sky, the sound of gentle waves echoed along the shore while I ran barefoot on the warm sand, holding my mother's hand and searching for colorful seashells with my family.”

The server generates an image generation prompt sentence on the basis of the extended text. The server applies another analysis module to the extended text to extract richer visual detail, including objects, lighting conditions, camera viewpoint, and style descriptors. The server constructs an image generation prompt sentence such as “Create a high-resolution illustration of a summer seaside scene with a bright blue sky, gentle waves, warm golden sand, and a family collecting colorful seashells on the shore, with a nostalgic and warm atmosphere.” The image generation prompt sentence is stored as a structured string in memory.

The server transmits the image generation prompt sentence to an image generation model. The image generation model may be implemented as a neural network based on a diffusion architecture, a generative adversarial network, or a similar generative architecture. In one embodiment, the image generation model is a text-conditioned diffusion model. During training, the diffusion model learns to reconstruct images from corrupted versions using a denoising network, with a loss function such as mean squared error between predicted and target noise, conditioned on text embeddings derived from the prompt. During inference, the model starts from random noise and iteratively refines the image representation through multiple time steps guided by the text embedding. The server sends the image generation prompt sentence to a text encoder associated with the image generation model, which converts the sentence into an embedding vector. The server controls generation parameters such as number of diffusion steps, guidance scale, and image resolution.

The server acquires visual expression data from the image generation model. The visual expression data may be represented as a multidimensional tensor in memory, corresponding to pixel values in an RGB color space or another color representation. The server converts the tensor into a standard image format, such as PNG or JPEG, and stores the converted data as image data in non-volatile storage. The server associates the image data with the extended text, the original text data, the preprocessed text data, and the extracted emotion and visual elements in a relational or document-oriented database. The server defines a data schema that links these items via a session identifier or user identifier, thereby enabling reuse and regeneration.

The server converts the extended text and the visual expression data into an output data format suitable for use as digital content. The server may generate multiple variants of the output data, such as a version sized and compressed for use as a background image on a portable information device, a version formatted for printing as a poster, and a version embedded in a digital booklet. The server stores metadata such as resolution, aspect ratio, and color profile in association with each variant.

The server transmits the output data to the terminal. The terminal receives the output data and renders the extended text and the visual expression data on the display device. The terminal may display the extended text in a scrollable text area and display the generated image in a dedicated image region. The user views the output and may choose to set the image as a wallpaper, print the image, or save the combined text and image as a digital memory artifact.

The server stores the text data, the preprocessed text data, the extended text, and the visual expression data in the storage device in a way that supports reuse and regeneration. For example, the server maintains an index that maps from the user identifier and emotion type to stored sessions. When the user later submits a related prompt sentence, the server retrieves similar prior sessions and can re-use the extended text or the image prompt as part of a new generation request. This reduces redundant computation, shortens response time, and lowers communication load to external models.

The server achieves technical improvements to computer technology by structuring and optimizing data flows and model interactions. The preprocessing step reduces noise and normalizes the text data before tokenization by the generative AI model, which improves tokenization accuracy, reduces the number of out-of-vocabulary tokens, and stabilizes the model's inference time. The explicit extraction and numerical representation of emotion elements allow the server to adjust prompt sentences systematically, which reduces trial-and-error calls to the generative AI model and decreases the number of iterations required to obtain a desired output. The structured generation of image prompts based on the extended text and explicit visual elements leads to more consistent and semantically aligned images, thereby reducing the need for repeated image generation attempts.

The server further improves computation efficiency by decoupling preprocessing and emotion analysis from the main generative AI inference, enabling these tasks to be executed on local hardware using optimized libraries. The use of structured storage and reuse of intermediate artifacts reduces repetitive calls to remote models and decreases network traffic. By controlling model parameters and input formats in a rule-based and data-driven manner, the server reduces variance in model output length and content, which in turn improves predictability for resource allocation on the server.

The generative AI model and the image generation model both operate according to specific, disclosed architectures and training methods that differ from simple rule-based automation of human work. The generative AI model uses attention mechanisms, learned embedding spaces, and large-scale optimization to compute relationships between distant tokens that cannot be easily replicated by manual rules. The image generation model uses iterative denoising steps parameterized by learned weights to construct images from noise, following a non-intuitive generation path that does not resemble human drawing procedures. The server exploits these properties by providing structured prompts and controlling inference parameters, thereby achieving a level of content quality, emotional alignment, and computational efficiency that cannot be obtained by straightforward manual authoring or naive forwarding of user input to a model.

In another embodiment, the server may perform additional processing such as style control or safety filtering. The server may integrate a secondary classifier that evaluates extended text or visual expression data for policy compliance, using a separate neural network trained with a classification loss. The server can adjust prompt sentences or generation parameters based on classifier outputs, improving reliability and safety without requiring human review of every output.

In yet another embodiment, the server may implement an alternative emotion analysis algorithm that combines rule-based lexicon scoring with neural embeddings. The server may map tokens to vector representations using a learned embedding matrix, compute an aggregate sentence embedding, and feed the embedding into a regression model that outputs a continuous emotion score. The server may combine this score with lexicon-based counts of positive and negative words. This hybrid approach improves robustness across domains and languages, increasing the accuracy of emotional nuance control.

In a further embodiment, the server may employ different image generation models depending on resource constraints or target use. For low-latency scenarios, the server may select a lightweight generative model with fewer layers and lower resolution output, while for high-quality printing, the server may select a higher-capacity model with more diffusion steps. The server stores configuration profiles that map target output formats to specific model settings and uses these profiles to determine which model to invoke and what parameters to set. This dynamic selection improves both processing speed and quality for different uses.

The terminal can also implement local caching and display optimizations. The terminal may cache frequently used images or extended texts to reduce repeated downloads and to allow offline viewing. The terminal can adapt display resolution and compression based on its hardware capabilities, such as display pixel density and available memory, thereby improving user experience and reducing rendering latency.

Through these embodiments, the server, the terminal, and the cooperative processing pipeline implement more than an abstract idea or simple automation of human creative work. The system defines specific data structures, model interaction protocols, and algorithmic flows that improve the technical performance of text and image generation in a distributed computing environment. The structured preprocessing, emotion quantification, controlled prompt generation, model parameter tuning, and artifact reuse collectively enhance computational efficiency, resource usage, and output quality in a way that is rooted in improvements to computer technology itself.

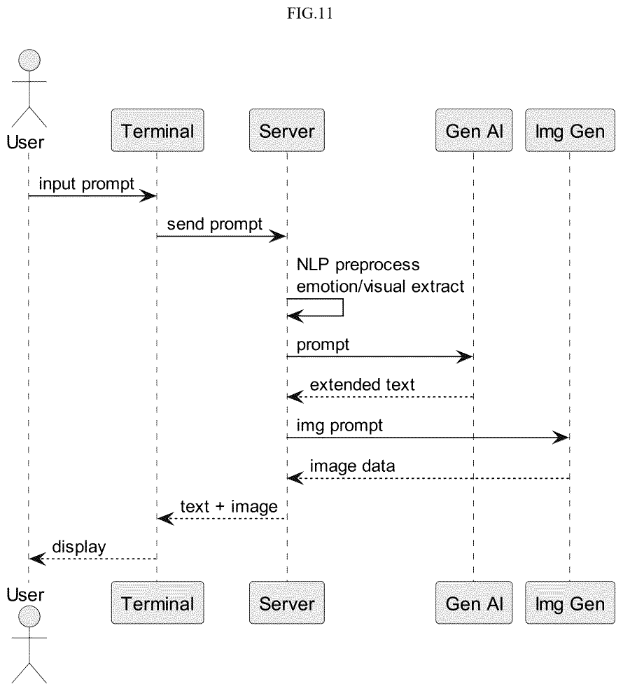

The following describes the processing flow using FIG. 11.

### Step 1:

The user operates the terminal to launch an application or web client and open a memory input screen. The user inputs a prompt sentence, such as “the summer seaside scenery I spent as a child with my family,” via a keyboard or touch interface. The input is text characters entered by the user. The terminal converts the keystrokes or touch events into a UTF-8 encoded text string and stores this string in a memory buffer as text data. The output of this step is the text data representing the prompt sentence together with metadata such as a timestamp and a user identifier.

### Step 2:

The terminal constructs a request message containing the text data and associated metadata. The input to this step is the UTF-8 text string and local metadata. The terminal encapsulates the text data into a structured payload (for example, a body with fields for prompt sentence, language code, and user ID) and adds protocol headers (for example, HTTP headers with content type and authentication tokens). The terminal performs a data formatting operation that converts the internal string representation into a byte sequence suitable for network transmission. The output of this step is a network-ready request message that can be sent over a communication network.

### Step 3:

The terminal transmits the request message to the server via a communication network. The input is the network-ready request message. The terminal's communication module establishes a secure connection (for example, using TLS) and sends the byte sequence to a predefined server endpoint. This involves segmentation of the message into packets and scheduling the packets on a network interface. The output of this step is the delivery of the request message to the server side and an acknowledgment at the transport layer.

### Step 4:

The server receives the request message and parses the payload. The input to this step is the raw byte stream arriving at the server's communication interface. The server's network stack reassembles the packets into a complete message and passes it to an application handler. The server decodes the byte sequence into text using the appropriate character encoding and extracts the prompt sentence, user ID, and other metadata by parsing the structured payload. The output of this step is an internal data structure containing the raw text data, the user context, and the request attributes stored in server memory.

### Step 5:

The server performs preprocessing on the text data using natural language processing libraries. The input is the raw prompt sentence as a string. The server loads language models and tokenizer components (for example, components analogous to those in spaCy or NLTK) into memory and applies tokenization, normalization, and filtering. The server converts the string into a list of tokens, removes unnecessary characters such as control symbols and redundant whitespace, and may normalize case or punctuation. The server thus performs data transformation from an unstructured character sequence to a structured representation. The output is preprocessed text data, including a normalized text string and an ordered token list.

### Step 6:

The server performs emotion analysis on the preprocessed text data to extract an emotion element. The input is the preprocessed string and token list. The server computes a feature vector by applying feature extraction algorithms, such as counting sentiment-bearing terms, computing n-gram statistics, or generating embedded vectors using a pre-trained embedding model. The server feeds this feature vector into an emotion classifier implemented as a machine learning model (for example, a neural network or another classifier) and obtains a probability distribution over emotion categories and an intensity score. The server converts these outputs into a numerical index describing emotion type and strength. The output of this step is the emotion element represented as one or more numerical values associated with the prompt sentence.

### Step 7:

The server extracts a visual element from the preprocessed text data. The input to this step is the same preprocessed string and token list. The server applies a syntactic parser to compute a dependency tree or parse tree, then traverses the tree to detect nouns, adjectives, and phrases that refer to physical scenes, objects, colors, and spatial relations. The server selects terms such as “seaside,” “summer,” “family,” “blue sky,” and “waves,” and places them into a structured container, such as a list or graph of visual concepts with attributes and relations. The output is the visual element, stored as a data structure describing scene components derived from the prompt sentence.

### Step 8:

The server generates a generation instruction sentence including a prompt sentence for a generative AI model. The inputs are the preprocessed text data, the emotion element, and the visual element. The server applies rule-based templates and conditional logic to combine these inputs into a new natural language instruction. The server may insert the emotion type and intensity into phrases like “emotionally rich,” “strong nostalgia,” or “gentle happiness,” and insert the visual concepts into descriptive phrases. The server thus transforms structured numerical and symbolic representations into a grammatically coherent instruction text. The output is a refined prompt sentence (generation instruction sentence) ready to be sent to the generative AI model.

### Step 9:

The server constructs generation request data for the generative AI model. The input is the refined prompt sentence and model control parameters (such as maximum length and randomness settings). The server encodes the prompt sentence into a token sequence using the tokenizer associated with the model and encapsulates the tokens and control parameters into a request object. This requires mapping each token to a vocabulary index and arranging indices into an array or tensor data structure. The output of this step is a generation request that includes model-specific token identifiers and parameter values.

### Step 10:

The server transmits the generation request data to the generative AI model and receives extended text as a response. The input is the model-ready request object. The server sends this object to a model execution environment (which may be remote) via a communication interface. The generative AI model performs multiple matrix operations and non-linear activations across its neural network layers, computing next-token probabilities and sampling tokens until a stopping condition is reached. The server receives a sequence of output token identifiers, decodes them back into characters, and concatenates them into a natural language string. The output of this step is extended text that elaborates on the original prompt sentence in more detail.

### Step 11:

The server analyzes the extended text to generate an image generation prompt sentence. The input is the extended text string. The server applies similar parsing and concept extraction as in previous steps but now targets richer visual details present in the extended narrative. The server identifies additional objects, environmental conditions, and stylistic cues (for example, “warm golden sand,” “gentle sound of waves,” “nostalgic atmosphere”). The server formats these details into an image-focused description, adding directives such as “high-resolution,” “illustration,” or “photorealistic” as appropriate. The output is an image generation prompt sentence tailored for an image generation model.

### Step 12:

The server constructs an image generation request and sends it to an image generation model. The input is the image generation prompt sentence and target image parameters (resolution, aspect ratio, style). The server encodes the prompt sentence into a text embedding via a text encoder associated with the image generation model, generating a floating-point vector representation. The server packages the embedding and image parameters into a request structure suitable for the diffusion or generative model. The output of this step is an image generation request containing numerical embeddings and configuration parameters.

### Step 13:

The server obtains visual expression data from the image generation model and converts it to an image file. The input is the image generation request. The image generation model, using its internal neural network architecture, iteratively refines a latent image representation into a pixel-level tensor. The server receives this tensor and converts the numeric pixel values into a standard image file format by applying color space transformations and compression algorithms. The output of this step is visual expression data as an image file (for example, in PNG or JPEG format) stored in server memory or storage.

### Step 14:

The server associates and stores data elements in a storage device for reuse or regeneration. The inputs are the original text data, the preprocessed text data, the emotion element, the visual element, the refined prompt sentence, the extended text, and the visual expression data. The server writes these items into a database or file storage system using a defined schema, linking them via identifiers such as session ID and user ID. The server may also store derived indices for fast lookup, such as emotion category indexes or hash values of prompt sentences. The output of this step is a persistent record that can be retrieved later to avoid redundant computation.

### Step 15:

The server converts the extended text and the visual expression data into one or more output data formats. The input is the extended text string and the image file. The server generates different layouts or resolutions depending on target uses, such as wallpaper, poster, or digital booklet. The server may resize or crop the image, adjust compression levels, and wrap text in markup suitable for the terminal's display environment. Each variant is stored as an output object with metadata describing its use case. The output of this step is one or more formatted output data packages ready for delivery to the terminal.

### Step 16:

The server transmits the selected output data package to the terminal. The input is the formatted output data (for example, extended text plus an image variant) and destination information for the terminal. The server prepares a response message, encodes the data into a byte stream, and sends it via the communication network using a response protocol. The output of this step is the successful delivery of the extended text and visual expression data to the terminal.

### Step 17:

The terminal receives the output data and renders it on the display device. The input is the response message containing the extended text and image file. The terminal decodes the message, extracts the text and image data, and loads them into its graphics and text rendering subsystems. The terminal allocates display regions, draws the image at the appropriate resolution, and lays out the extended text in a scrollable or paged view. The output of this step is a graphical user interface showing the generated narrative and its corresponding visual representation.

### Step 18:

The user views and interacts with the displayed extended text and visual expression data on the terminal. The input to this step is the rendered screen content. The user may scroll through the narrative, zoom into the image, or select commands to save the image as wallpaper or export the content. The user's actions produce interaction events that the terminal converts into new commands or requests. The output of this step can be new input data (such as a refined prompt sentence or a reuse request), which can be sent back to the server to initiate another cycle of the processing flow.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content generation systems that utilize natural language input and generative artificial intelligence models are typically designed to produce static images or simple digital content, such as posters or wallpapers, based on direct textual prompts. In such systems, the processing is often limited to a straightforward mapping from user-provided text to generated image data, without deeply analyzing the emotional nuance or visual structure inherent in the text. As a result, these systems frequently fail to produce visual content that accurately reflects a user's subjective memory, emotional state, or desired immersive experience.

Furthermore, known systems generally treat the generative artificial intelligence model as an opaque backend service and do not optimize the upstream and downstream processing surrounding the model. In particular, the following technical issues arise:
(1) The absence of systematic extraction and structuring of emotional information and visual information from natural language input leads to prompts that are suboptimal for driving a generative artificial intelligence model, resulting in images that are vague, inconsistent, or semantically misaligned with the user's intent.
(2) The lack of a coordinated mechanism for generating model-specific prompt sentences and generation parameters, including resolution, style, and layout conditions, prevents efficient and accurate control of the generative process, and degrades the quality and reproducibility of the output.
(3) The generated image data is not natively prepared for heterogeneous output paths, such as two-dimensional displays and immersive virtual reality displays, and therefore requires ad hoc client-side processing, causing latency, inconsistent rendering, and increased computational load on user devices.
(4) Emotion analysis, when present, is typically decoupled from the generative pipeline, so emotional nuance is not consistently or quantitatively reflected in the visual attributes, atmosphere, or style of the generated scene. This limits the ability of the system to reconstruct user memories in a manner that is both visually accurate and emotionally resonant.

From a computer-technology perspective, these issues manifest as inefficiencies and limitations in the end-to-end data processing pipeline for immersive content generation: natural language is not transformed into machine-usable structured features in an optimized way; prompt construction for the generative artificial intelligence model does not fully exploit available semantic and emotional information; server-side processing does not adequately precondition data for diverse display modalities; and the computational roles between server and terminal are not clearly partitioned to achieve low latency and high quality in virtual reality rendering. There is a need for a technical framework that improves the way computing resources, algorithms, and data transformations are orchestrated, so that natural language memories can be transformed into high-fidelity, emotion-aware, immersive visual experiences.

Accordingly, an object of the present invention is to provide a system and corresponding server-side processing that: (i) performs structured extraction of emotional and visual features from natural language description data, (ii) generates optimized prompt sentences and generation parameters for a generative artificial intelligence model, (iii) executes server-side conversion of generated image data into formats suitable for both two-dimensional and virtual reality display, and (iv) tightly integrates emotion analysis results into the generative control pipeline. These improvements aim to enhance the efficiency, accuracy, and quality of computer-implemented content generation, particularly for immersive virtual reality experiences.

The specific processing by the specific processing unit 290 of the data processing device 12 in Application Example 1 is realized by the following means.

The present invention provides a server comprising a processor configured to receive description data expressed in natural language as input from a user via a communication network, to analyze the description data by using a natural language processing algorithm to extract feature information including emotional information and visual information from the description data, to generate generation instruction information by constructing a prompt sentence for input to a generative artificial intelligence model on the basis of the feature information and combining the prompt sentence with generation parameters including image generation conditions, to execute an image generation process by transmitting the generation instruction information to the generative artificial intelligence model so as to cause the generative artificial intelligence model to generate image data as a visual representation corresponding to the description data and to obtain the image data, and to perform conversion processing on the image data in accordance with a type of display apparatus and a virtual reality display mode so as to convert the image data into an output format including a two-dimensional display format or a virtual reality experience format, and to transmit the image data converted into the output format to a display apparatus including a head-mounted display so as to present the image data to the user as an immersive virtual reality experience. This enables the computing system to transform natural language memories into emotion-aware, semantically aligned visual content by optimizing both the prompt generation for the generative artificial intelligence model and the server-side formatting of generated image data, thereby improving end-to-end processing efficiency, output quality, and suitability for heterogeneous display environments including immersive virtual reality.

The term “system” refers to an arrangement including at least one processor and one or more peripheral components that cooperate to execute programmed instructions for processing input data and generating output data.

The term “processor” refers to one or more hardware processing units, such as a central processing unit or a graphics processing unit, that execute machine-readable instructions to perform data processing operations.

The term “description data” refers to digital text data expressed in natural language and provided by a user to describe a memory, scene, event, or impression to be visually represented.

The term “natural language” refers to a human language, such as a spoken or written language used in everyday communication, as opposed to a programming language or other formal language.

The term “user” refers to a human operator who interacts with the system by providing input data and viewing or experiencing output data.

The term “natural language processing” refers to a class of computational techniques for analyzing and interpreting natural language text to extract structured information such as syntax, semantics, and sentiment.

The term “feature information” refers to structured data derived from description data, including attributes and parameters that characterize emotional aspects and visual aspects of the content described by the user.

The term “emotional information” refers to data representing a type, intensity, or nuance of emotion inferred from description data, such as happiness, sadness, nostalgia, or excitement.

The term “visual information” refers to data representing visual elements and attributes inferred from description data, such as objects, backgrounds, colors, lighting conditions, scenes, or spatial relationships.

The term “prompt sentence” refers to a text string constructed for input to a generative artificial intelligence model so as to control the model's behavior in generating visual content.

The term “generation parameters” refers to control values supplied to a generative artificial intelligence model in addition to a prompt sentence, including conditions such as resolution, aspect ratio, number of images, style, and other generation-related settings.

The term “image generation conditions” refers to a subset of generation parameters that specify technical constraints or requirements for image generation, such as target resolution, output format, geometric layout, or level of detail.

The term “generation instruction information” refers to a combination of at least one prompt sentence and at least one generation parameter that together instruct a generative artificial intelligence model to perform an image generation process.

The term “generative artificial intelligence model” refers to a machine learning model configured to generate new data, such as image data, based on input data including prompt sentences and generation parameters, the model typically being implemented by a neural network.

The term “image generation process” refers to a sequence of computational steps executed by a generative artificial intelligence model to produce image data from input data including a prompt sentence and generation parameters.

The term “image data” refers to digital data representing a visual image, including pixel values encoded in a format such as a raster image file or an in-memory bitmap.

The term “visual representation” refers to a graphical depiction generated from description data, in the form of image data, that corresponds to the content or emotion described by a user.

The term “conversion processing” refers to a set of operations applied to image data to transform its format, resolution, aspect ratio, or layout so as to adapt the image data to characteristics of a target display apparatus or display mode.

The term “display apparatus” refers to any hardware device configured to output visual information to a user, including a portable information terminal, a stationary display, or a head-mounted display.

The term “head-mounted display” refers to a display apparatus worn on a user's head that presents visual content in close proximity to the eyes, typically enabling stereoscopic presentation and immersive viewing.

The term “type of display apparatus” refers to a classification of display hardware based on characteristics such as form factor, resolution, viewing distance, and support for stereoscopic or immersive display.

The term “virtual reality display mode” refers to a display configuration in which image data is presented so as to provide an immersive or semi-immersive experience, including stereoscopic presentation, head-tracked viewpoint changes, or 360-degree environments.

The term “output format” refers to a data format or layout of image data adapted for presentation on a specific display apparatus or in a specific display mode, including two-dimensional display formats and virtual reality experience formats.

The term “two-dimensional display format” refers to an image format suitable for presentation as a flat image on a conventional display surface without stereoscopic separation or immersive mapping.

The term “virtual reality experience format” refers to an image format or arrangement suitable for immersive or semi-immersive viewing, including formats used for stereoscopic rendering, panoramic display, or environment mapping in a virtual space.

The term “portable information terminal” refers to a portable electronic device configured to display information and communicate with external systems, such as a smartphone, tablet, or handheld computing device.

The term “display unit” refers to a component of a display apparatus that provides a visible surface, such as a screen or panel, on which image data is rendered for viewing.

The term “resolution” refers to a measure of the number of pixels or spatial sampling points in image data or on a display unit, typically expressed as a width by height in pixels.

The term “aspect ratio” refers to a proportional relationship between the width and height of an image or display area, expressed as a ratio of width to height.

The term “binocular parallax display” refers to a display method in which different images are presented to the left and right eyes to create a perception of depth and three-dimensional structure.

The term “background display in a virtual space” refers to a method of rendering image data as a surrounding or distant environment in a virtual three-dimensional scene, such that the image functions as a backdrop around a user's viewpoint.

The term “emotion analysis algorithm” refers to a computational procedure that processes description data to identify one or more emotional categories and corresponding intensities.

The term “type of emotion” refers to a categorical label representing a particular emotional state, such as joy, sadness, fear, anger, or nostalgia, inferred from description data.

The term “intensity of emotion” refers to a quantitative or qualitative measure indicating the strength or degree of an identified type of emotion.

The term “style information” refers to data that specifies aesthetic characteristics of a visual representation, such as realism level, artistic style, color tone, or rendering technique.

The term “atmosphere information” refers to data that specifies overall mood or ambience of a visual representation, such as calm, tense, warm, or melancholic, and is used to control the generative artificial intelligence model.

The term “communication network” refers to a wired or wireless network infrastructure that enables transmission of data between a server, a display apparatus, and other devices.

The server, the terminal, and the user cooperate to implement the invention in various embodiments as described below. Each embodiment is configured to support the scope of the claims and to enable a person skilled in the art to realize the claimed system in practice.

The server includes at least one processor, a main memory, a non-volatile storage device, and a network interface. The server runs a server-side operating system, such as a generic server operating system, and executes application software implemented, for example, using a web application framework such as a Python-based framework or a JavaScript-based framework.

The server further has access to a generative AI model execution environment deployed either as an external network service or as a local inference service running on a computation node equipped with a graphics processing unit (GPU), for example a general-purpose GPU supporting parallel numeric computation.

The terminal includes at least one processor, a memory, a display unit, one or more input devices such as a touch panel or physical buttons, and a communication module. The terminal is implemented, for example, as a portable information terminal such as a smartphone, a tablet, or a head-mounted display, and runs a client application or a browser-based application that communicates with the server via a communication network.

The user operates the terminal to provide description data and to experience generated visual representations. The user inputs description data in natural language through a text input interface or a voice input interface on the terminal. The user can provide, for example, a prompt sentence such as:
“A summer seaside landscape from my childhood: bright blue sea, white sandy beach, a small yacht in the distance, and a clear sunny sky, photorealistic, wide-angle view.”
or
“The snowy mountain town I visited with my family: warm lights from wooden houses, falling snow at night, a quiet street, cozy atmosphere, highly detailed, cinematic lighting.”
or
“My university graduation day in front of the main building: friends in graduation gowns, blue sky, cherry blossoms in bloom, joyful and nostalgic mood, semi-realistic illustration style.”

The terminal formats the user's description data as text and transmits it to the server. The terminal may also transmit metadata such as a device identifier, display capabilities (for example, supported resolution, aspect ratio, and whether a stereoscopic mode is supported), and user preference information (for example, preferred image style or level of realism).

The server stores the received description data in a structured data store. For example, the server stores a record including a text field for the raw description data, a field for a language code, and fields for analysis results such as emotion type, emotion intensity, and visual feature tokens. The server utilizes a natural language processing module implemented as a software component using, for example, a general-purpose natural language processing library. The natural language processing module performs operations including tokenization, part-of-speech tagging, syntactic parsing, and semantic role labeling. The server uses these operations to transform the unstructured description data into structured feature information.

The server extracts emotional information from the description data by executing an emotion analysis algorithm. In one embodiment, the emotion analysis algorithm is implemented as a neural network classifier trained on a labeled corpus of text and configured to output both an emotion category and an emotion intensity score. The classifier uses a text encoder, such as a transformer-based encoder, which converts the tokenized description data into contextual embeddings. A final classification layer maps the embeddings to a vector of emotion category probabilities. The server selects one or more dominant emotion categories and computes an intensity value, for example by taking a weighted sum of probabilities or by normalizing raw logits. This processing provides a quantifiable emotional profile that can be embedded into subsequent generation parameters.

The server extracts visual information by identifying text spans corresponding to objects, scenes, environmental conditions, color terms, temporal expressions, and style modifiers. The server uses the syntactic structure and semantic roles identified by the natural language processing module to construct a visual feature graph. Nodes in the visual feature graph represent entities such as “sea,” “beach,” “yacht,” and “sky.” Edges represent relationships such as spatial relations (“in the distance,” “on the beach”), attributes (“blue,” “white,” “bright”), and temporal context (“summer,” “night”). The server stores the visual feature graph as an adjacency list or other graph data structure in memory.

The server generates a prompt sentence for input to the generative AI model by traversing the visual feature graph and mapping nodes and edges to a refined text representation. The server applies generation rules that order entities in a way that aligns with the generative AI model's training distribution, for example placing global scene descriptors earlier and fine-grained details later. The server also injects explicit style tokens and atmosphere tokens derived from the emotional information. For example, if the emotion analysis yields a strong nostalgic and warm emotion, the server appends or reinforces phrases such as “nostalgic,” “warm atmosphere,” or “soft lighting” in the prompt sentence.

The server combines the prompt sentence with generation parameters to form generation instruction information. The server selects an image resolution, aspect ratio, and number of output images depending on the capabilities and preferences associated with the terminal. For example, for a smartphone display, the server chooses a resolution matching or slightly exceeding the physical display resolution and an aspect ratio such as 16:9 or 19.5:9. For a head-mounted display used in an immersive mode, the server selects a square or wide resolution suitable for later projection onto a virtual sphere or for stereoscopic rendering. The server also sets model-specific parameters such as guidance scale for a diffusion model, sampling steps, and random seed.

The generative AI model in one embodiment is a text-to-image diffusion model. The server, or a cooperating inference node, runs a diffusion model including a text encoder, a UNet-based denoising network, and a variational autoencoder (VAE) decoder. The text encoder converts the prompt sentence into a sequence of embedding vectors. The UNet denoising network, conditioned on the text embeddings and guided by the generation parameters, iteratively denoises a tensor of random noise. After a fixed number of denoising steps, the server obtains a latent representation, which is decoded by the VAE decoder into image data.

The server configures the inference pipeline to use batch processing and optimized GPU kernels, thereby reducing latency and increasing throughput compared to naive implementations.

In another embodiment, the generative AI model is an autoregressive image generator or a generative adversarial network. The server stores multiple model variants and selects an appropriate model based on the requested style or output format. For example, the server uses a diffusion model for photorealistic scenes and a generative adversarial network with a specific style encoder for illustration-style outputs. This flexible selection improves overall image quality for diverse use cases.

The server performs training or fine-tuning of the generative AI model and emotion analysis model using a training pipeline that includes data augmentation, a predefined loss function, and weight update rules. For example, the server uses a cross-entropy loss for emotion classification and a combination of reconstruction loss and adversarial loss for generative models. The server applies gradient-based optimization such as stochastic gradient descent or an adaptive optimizer. During training, the server stores intermediate model parameters and evaluation metrics in a model registry. This infrastructure enables continuous improvement of model accuracy and stability without requiring modifications on the terminal side.

The server converts the generated image data into an output format appropriate for the target display apparatus. The server uses an image processing library to perform resizing, cropping, and color-space conversion. If the terminal is a head-mounted display, the server prepares the image data as a texture for a virtual environment. For example, the server generates an equirectangular image suitable for 360-degree mapping or prepares two images offset for left and right eyes to create binocular parallax. The server also adjusts gamma and color balance to compensate for known characteristics of the display apparatus.

The terminal receives the converted image data and displays it using a rendering engine. For a conventional smartphone, the terminal uses a standard image rendering component of the operating system to display the two-dimensional image. For a head-mounted display or a smartphone inserted into a head-mounted mount, the terminal uses a three-dimensional rendering engine, such as a generic game engine or a Web-based extended reality framework, to map the image data onto a virtual screen or a virtual dome. The terminal reads gyro and accelerometer sensor data to update the viewpoint in real time, providing an immersive virtual reality display mode.

The server and the terminal cooperate to achieve technical improvements beyond mere automation of human tasks. The server performs computationally intensive natural language processing, graph construction, and generative inference centrally, thereby reducing the processing load on the terminal and enabling thinner client implementations. The server constructs structured feature information and a visual feature graph that humans do not typically construct explicitly, and uses these structures to generate optimized prompt sentences. This procedure reduces ambiguity in the input to the generative AI model and yields more accurate and consistent visual representations. Because the prompt sentence and generation parameters are systematically derived from structured representations, the generative process becomes predictable and reproducible, which is difficult to achieve with ad hoc human prompt design.

The server improves data management by storing not only raw description data but also intermediate feature information, emotion profiles, and generation parameters in a normalized database schema. The server can reuse this information to regenerate images with modified resolutions or for different display apparatus types without re-executing full natural language analysis. This reduces redundant computation, shortens response time, and reduces communication load between the server and the generative AI model execution environment.

The server also improves computational efficiency by batching multiple generation requests and sharing intermediate computations where feasible. For example, if multiple prompt sentences share similar base content but differ in style modifiers, the server can cache text encoder outputs and reuse them in separate diffusion runs. This non-human optimization of internal model usage improves throughput and reduces energy consumption at the datacenter level.

The server applies specific internal rules for mapping emotional information to visual attributes that differ from conventional human workflows. For instance, the server applies a mapping table that links emotion categories and intensity values to color temperature ranges, contrast levels, and composition bias. A strong nostalgic emotion may bias the generative parameters toward warmer color temperatures and lower contrast, while a tense emotion may bias toward cooler colors and high contrast. The server encodes these rules into the prompt sentence and generation parameters automatically, which achieves consistent and quantifiable emotional rendering that is difficult for human operators to perform manually, particularly at scale.

The server further improves technical quality of virtual reality rendering by performing server-side layout optimization. When generating images for a virtual reality experience format, the server computes a mapping between scene elements and angular coordinates of a virtual sphere. The server can generate multiple tiles representing different view directions and assemble them into a composite equirectangular image. This tiling and compositing process is optimized to reduce distortion in regions that are most likely to be viewed, based on statistical head-movement models. As a result, the system reduces perceptual distortion for the user while keeping image resolution and file size within device and network constraints.

The server and the terminal can adopt alternative configurations. In one variation, the generative AI model is hosted externally as a cloud service and the server acts as an orchestrator that performs natural language processing and image post-processing while delegating core image generation to the external model. In another variation, the server hosts a full local inference engine, using one or more GPUs, enabling offline or low-latency deployment in environments with limited network connectivity. In yet another variation, part of the natural language processing or emotion analysis is performed on the terminal for privacy or latency reasons, with only structured feature information transmitted to the server.

The user may use the system in different usage scenarios. The user can generate a two-dimensional image to be displayed on a smartphone as a static wallpaper or a lock screen background. The user can also use a head-mounted display to experience the same generated scene as an immersive environment, looking around by turning the head. In both cases, the underlying data processing pipeline and the generative AI model usage are optimized by the server to ensure that the output is technically well-adapted to the specific display modality.

By combining structured natural language analysis, formalized emotional feature extraction, model-specific prompt sentence construction, optimized generation parameter selection, and server-side conversion of image data into two-dimensional and virtual reality experience formats, the server improves the functioning of the overall computer system. The system not only automates a human task but also implements a non-conventional data processing pipeline and model control mechanism that enhances processing speed, output accuracy, resource utilization, and the quality of immersive visual experiences.

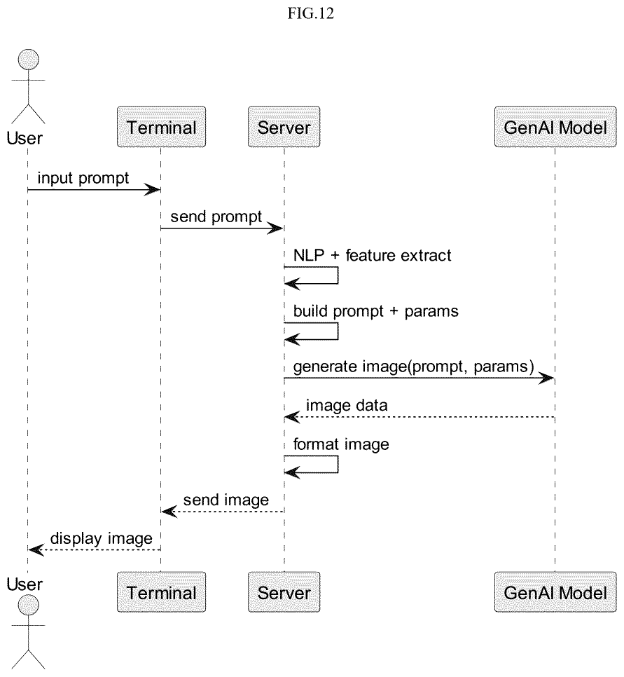

The following describes the processing flow using FIG. 12.

### Step 1:

User operates the terminal to input description data.

User recalls a memory scene and enters a prompt sentence into a text input field on the terminal, for example: “A summer seaside landscape from my childhood: bright blue sea, white sandy beach, a small yacht in the distance, and a clear sunny sky, photorealistic, wide-angle view.” The input of this step is raw natural language text typed or dictated by the user.

The output of this step is structured input data held on the terminal, including the prompt sentence and optional user preferences such as desired style or realism level.

### Step 2:

Terminal formats and transmits the description data to the server.

Terminal receives the user's prompt sentence, validates that it is non-empty and within a preset maximum length, normalizes whitespace and character encoding, and encapsulates the prompt sentence together with device capability information (for example, display resolution and whether virtual reality mode is supported) into a request message. The input of this step is the user's prompt sentence and device metadata. The output of this step is a serialized request, for example a JSON object, transmitted over a communication network to the server via a secure protocol.

### Step 3:

Server receives and stores the description data.

Server accepts the incoming request from the terminal through a network interface, parses the serialized structure, and extracts the prompt sentence and associated metadata. The server then stores this information in a persistent data store, assigning a unique identifier to the request. The input of this step is the serialized request from the terminal. The output of this step is a database record that includes the raw description data, device information, and a request identifier used in later processing.

### Step 4:

Server performs natural language preprocessing on the description data.

Server loads the prompt sentence from the database or in-memory structure and passes it to a natural language processing module. The server performs tokenization, part-of-speech tagging, lemmatization, and syntactic parsing. The server converts the sequence of tokens into internal data structures, such as lists of token objects and parse trees, and identifies key phrases corresponding to entities, attributes, and relations. The input of this step is raw text from the description data. The output of this step is a set of structured linguistic features, including token sequences, syntactic trees, and labeled phrases.

### Step 5:

Server extracts emotional information from the description data.

Server applies an emotion analysis algorithm to the tokenized and parsed text. The server encodes the text into numeric vectors using a text encoder and feeds these vectors into an emotion classification neural network that outputs probabilities for multiple emotion categories and corresponding intensity scores. The server then selects one or more dominant emotion categories and calculates normalized intensity values for each category. The input of this step is the structured linguistic features from natural language preprocessing. The output of this step is emotional information including emotion types (for example, nostalgic, joyful) and their intensity values, stored as numerical attributes.

### Step 6:

Server extracts visual information and constructs a visual feature graph.

Server analyzes the parsed text to identify references to objects, places, colors, lighting conditions, weather, time of day, and style descriptors. The server creates a visual feature graph in which nodes represent visual entities (for example, “sea,” “beach,” “yacht,” “sky”) and edges represent relations (for example, “in the distance,” “on,” “under a clear sky”). The server attaches attribute values such as color (“blue,” “white”) and temporal context (“summer”) to the corresponding nodes. The input of this step is the structured linguistic features obtained earlier. The output of this step is the visual feature graph and a set of visual attributes that will guide prompt sentence construction.

### Step 7:

Server constructs a refined prompt sentence for the generative AI model.

Server traverses the visual feature graph and assembles a new prompt sentence that orders global scene descriptors, main objects, attributes, and relations in a sequence that is effective for the generative AI model. The server incorporates emotional information by adding or adjusting style and atmosphere phrases, for example appending terms such as “nostalgic warm mood” when the emotional profile indicates a strong nostalgic and warm emotion. The input of this step is the visual feature graph and the emotional information. The output of this step is a refined prompt sentence specifically formatted as input text to the generative AI model.

### Step 8:

Server determines generation parameters for the generative AI model.

Server reads device information from the stored request record, such as display resolution, aspect ratio, and whether the target mode is two-dimensional display or virtual reality display. Based on this information, the server selects image resolution, aspect ratio, number of images, sampling steps, and model-specific control parameters, such as guidance strength for a diffusion model. The input of this step is device metadata and possibly user preferences.

The output of this step is a structured set of generation parameters that, together with the refined prompt sentence, form generation instruction information.

### Step 9:

Server generates generation instruction information and calls the generative AI model.

Server combines the refined prompt sentence and the generation parameters into a generation instruction object. The server then transmits this object to a generative AI model execution environment, either via an internal function call or via a network API, and initiates an image generation process. The input of this step is the refined prompt sentence and generation parameters. The output of this step is a request to the generative AI model that triggers neural network inference for image generation.

### Step 10:

Server obtains image data from the generative AI model.

Server receives the result of the image generation process, which includes one or more image tensors or encoded image files. If the model returns tensors, the server decodes them into a standard image format such as PNG or JPEG. The server verifies image dimensions and format and may store the image data in a file system or object storage with a link recorded in the database. The input of this step is the model's binary or tensor output. The output of this step is normalized image data representing a visual representation corresponding to the original description data.

### Step 11:

Server converts the image data into a device-specific output format.

Server checks the target device type and output mode (two-dimensional or virtual reality).

For a smartphone, the server resizes and crops the image to match the device's resolution and aspect ratio, and applies optional color and contrast adjustments. For a head-mounted display, the server converts the single image into a form suitable for immersive presentation, such as an equirectangular projection or separate left-eye and right-eye images for binocular parallax.

The input of this step is normalized image data and device metadata. The output of this step is formatted image data in an output format suitable for the terminal's display mode.

### Step 12:

Server transmits the formatted image data to the terminal.

Server embeds the formatted image data or a reference URL into a response message and sends this message to the terminal using the established communication channel. The server may compress the data if necessary to reduce transfer time. The input of this step is the formatted image data and a request identifier. The output of this step is a response message containing the visual representation and related metadata delivered to the terminal.

### Step 13:

Terminal receives and prepares the formatted image data for display.

Terminal accepts the response message from the server, parses the content, and extracts the formatted image data or its location. The terminal decodes the image data into a bitmap in memory and allocates appropriate rendering buffers. The input of this step is the response message from the server. The output of this step is ready-to-render image data stored in terminal memory along with any flags indicating two-dimensional or virtual reality display mode.

### Step 14:

Terminal renders the image data and presents the scene to the user.

Terminal invokes a rendering component suitable for the target mode. For a two-dimensional mode, the terminal displays the image in a standard view component and may offer the user an option to set it as a wallpaper or background. For a virtual reality mode, the terminal launches a three-dimensional rendering engine, maps the image data onto a virtual environment (for example, a virtual sphere or screen), and uses sensor readings from gyroscopes and accelerometers to update the viewpoint in real time. The input of this step is ready-to-render image data and device sensor readings. The output of this step is a visual presentation on the display unit, enabling the user to view and explore the generated scene as a static image or as an immersive virtual reality experience.

### Step 15:

User evaluates the generated visual representation and optionally refines the description data.

User observes the displayed scene and compares it with the intended memory or desired atmosphere. If the user wishes to adjust details such as color, time of day, or emotional tone, the user provides a new or updated prompt sentence on the terminal, for example: “The same summer beach, but at sunset: orange sky, calm waves, long shadows on the sand, slightly dreamy atmosphere, cinematic style.” The input of this step is the displayed image and the user's subjective evaluation. The output of this step is revised description data that can be processed again starting from the earlier steps to generate a refined visual representation.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems that convert user-authored text into images using generative AI models suffer from multiple technical limitations in how textual input is processed, represented, and utilized as prompts for such models. In many existing implementations, raw user text is passed directly or with minimal preprocessing to an image generation engine. As a result, the systems are unable to systematically extract scene-level structure, emotional nuance, and visually relevant attributes from the text, leading to prompts that are under-specified, noisy, or poorly aligned with the user's intent. This often produces unstable model behavior, inconsistent visual outputs, and inefficient use of computational resources due to repeated trial-and-error generations.

Furthermore, conventional prompt generation mechanisms typically do not employ a structured intermediate representation that separates and normalizes information such as scene outline, objects, time-of-day, atmosphere, and stylistic preferences. Without such a structured representation, the mapping from text input to prompt sentences is ad hoc, difficult to control, and sensitive to minor changes in the input text. This makes it challenging to ensure deterministic behavior, to optimize prompt length and content for a given generative AI model, or to reuse and refine prompts in an automated and traceable manner.

Additionally, existing systems often lack a technically integrated pipeline for emotion analysis and its explicit reflection in the visual output. Emotional cues embedded in user text are frequently ignored or only heuristically considered, which prevents consistent encoding of emotion-related parameters (such as emotion type and intensity) into the prompt that drives the image generation process. This results in images that may be visually plausible but do not accurately reflect the affective characteristics of the underlying text, thereby diminishing the functional quality and reliability of the system as a human-computer interaction technology.

Moreover, conventional architectures do not provide a robust feedback loop by which a user can iteratively refine or edit only the prompt sentence while preserving the previously extracted structured information, and then regenerate images under controlled variations. In many cases, each regeneration is treated as a completely new request, repeating full text analysis and discarding valuable intermediate representations. This causes unnecessary recomputation, increases latency, consumes additional processing resources, and makes it difficult to maintain a consistent visual narrative across multiple images derived from related text content.

Furthermore, existing systems often do not integrate post-processing steps that adapt model outputs into multiple device-and medium-specific formats in a technically unified manner. Image resolution, tone, and sharpness are often handled separately for each application scenario (such as display backgrounds versus printed media), which complicates system design and increases the likelihood of format conversion errors, visual degradation, or incompatibility with downstream devices.

Accordingly, there is a need for an improved computer-implemented system that (i) transforms natural language text into a structured representation of visual elements and emotional attributes, (ii) automatically generates optimized prompt sentences tailored for generative AI models based on that representation, (iii) incorporates explicit emotion analysis into the structured representation and prompts, (iv) supports user-driven prompt refinement while reusing existing structured information to enable efficient and controlled regeneration of images, and (v) performs integrated post-processing and format conversion to provide visual representations as device-and medium-specific outputs. Such a system should improve the technical functioning of the underlying computer platform by enabling more deterministic, resource-efficient, and semantically aligned interaction between language processing components and generative AI models.

The specific processing by the specific processing unit 290 of the data processing device 12 in Example 2 is realized by the following means.

The present invention provides a server comprising a processor and a memory storing instructions that, when executed by the processor, cause the server to receive text information expressed in a natural language from a user terminal and store the text information as structured data; to apply a language analysis technique to the text information to extract visual element information including emotion state information and scene information on the basis of meaning information and context information, and to generate structured information in which the visual element information is organized by attribute; to automatically generate prompt sentence information as description text including outline information of a scene, object information, time-zone information, atmosphere information, and expression-style information on the basis of the structured information, and to control an amount of text and contents of the prompt sentence information such that the prompt sentence information is suitable as input to a generative AI model for image generation; to transmit generation request information including the prompt sentence information to the generative AI model for image generation and acquire visual representation information as image data generated by numerical computation processing executed by the generative AI model; to apply an image processing technique to the visual representation information so as to adjust at least one of resolution information, tone information, and sharpness information and convert the visual representation information into output format information for display or print; and to provide the visual representation information, on the basis of the output format information, as background display information on an electronic display apparatus or as print image information on a print medium, and further to regenerate the prompt sentence information on the basis of the visual element information included in the structured information and corrected prompt sentence information input by an editing operation by a user, and to use the regenerated prompt sentence information as new input to the generative AI model for image generation to regenerate the visual representation information. This enables a computer system to more efficiently and reliably transform natural language input into structured visual control information, to generate optimized and emotionally consistent prompt sentences for a generative AI model, to reduce redundant computation through reuse of structured information during regeneration, and to output model-generated images in formats technically adapted to multiple display and print environments, thereby improving the overall technical performance and predictability of the text-to-image generation pipeline.

The term “text information expressed in a natural language” refers to character string data that represents human-authored sentences or phrases in a human language, and that is suitable for processing by a language analysis technique executed by a computer system.

The term “user terminal” refers to an electronic apparatus operated by a user, such as a portable information processing device, a stationary information processing device, or a web-enabled client device, that is configured to transmit text information to a server and to receive and display visual representation information.

The term “structured data” refers to data that is stored in a predefined format such as a record, an object, or a table, in which individual elements of text information are separated into identifiable fields or attributes that are directly processable by a program.

The term “language analysis technique” refers to a software-implemented procedure that analyzes text information using computational processing, including but not limited to tokenization, syntactic analysis, semantic analysis, context analysis, and statistical or machine learning-based processing.

The term “visual element information” refers to data representing components of a visual scene that are inferred from text information, including but not limited to information regarding locations, objects, subjects, temporal conditions, environmental conditions, and stylistic aspects that are suitable for use in generating an image.

The term “emotion state information” refers to data representing an inferred affective state, such as a type of emotion and an intensity of emotion, extracted from text information by computational processing.

The term “scene information” refers to data representing an overall situation or environment implied by text information, including spatial setting, temporal setting, and contextual background suitable for depiction in a visual representation.

The term “structured information” refers to an intermediate representation in which visual element information, emotion state information, and scene information are organized into discrete attributes or fields in a machine-readable format.

The term “prompt sentence information” refers to description text data that is generated on the basis of structured information and that is intended to be supplied as input to a generative AI model for image generation so as to control content and style of a generated image.

The term “outline information of a scene” refers to data within the prompt sentence information that broadly specifies a main setting or configuration of a visual scene, without necessarily providing all detailed elements.

The term “object information” refers to data within the prompt sentence information that specifies tangible or visual entities such as persons, animals, articles, or landscape components that are to be depicted in a generated image.

The term “time-zone information” refers to data that specifies temporal characteristics of a scene, including but not limited to time of day, season, or relative temporal context, as reflected in the prompt sentence information.

The term “atmosphere information” refers to data that expresses mood, tone, or emotional ambience of a scene, and that is derived at least in part from emotion state information and is incorporated into the prompt sentence information.

The term “expression-style information” refers to data that specifies a desired visual style or manner of depiction, such as illustration style, photography-like style, abstraction level, or other stylistic constraints for a generated image.

The term “generative AI model for image generation” refers to a machine learning model that receives prompt sentence information or equivalent control information and that generates image data using numerical computation, such as a neural network-based generative model.

The term “generation request information” refers to data transmitted to a generative AI model for image generation, including at least the prompt sentence information and optionally additional control parameters for the generation process.

The term “visual representation information” refers to image data generated by a generative AI model, which visually expresses content indicated by the prompt sentence information and is suitable for presentation on a display or for printing.

The term “numerical computation processing” refers to a sequence of arithmetic and logical operations performed by a processor or specialized hardware for executing a generative AI model, including vector and matrix operations and non-linear function evaluations.

The term “image processing technique” refers to a software-implemented procedure that modifies or analyzes image data, including but not limited to resizing, resampling, filtering, contrast adjustment, color adjustment, and sharpening.

The term “resolution information” refers to data indicating a spatial sampling density of an image, including at least a pixel width and a pixel height.

The term “tone information” refers to data indicating luminance or color balance characteristics of an image, including brightness, contrast, and color tone parameters.

The term “sharpness information” refers to data indicating edge definition or clarity in an image, and that can be modified by filtering or other image processing operations.

The term “output format information” refers to data specifying a representation format for an image to be provided to a device or medium, including at least file type, encoding parameters, resolution, and color space.

The term “electronic display apparatus” refers to a device that presents image data on an electronically controlled display surface, such as a display unit of a terminal, a display monitor, or a digital signage device.

The term “background display information” refers to image data and associated parameters used to display a visual representation as a background, wallpaper, or equivalent persistent image on a screen of an electronic display apparatus.

The term “print medium” refers to a physical recording substrate, such as paper or a printable sheet, onto which an image is transferred by a printing device.

The term “print image information” refers to image data and associated parameters formatted for transfer onto a print medium by a printing device.

The term “corrected prompt sentence information” refers to modified prompt sentence information that is input or edited by a user, based on previously generated prompt sentence information, for the purpose of controlling regeneration of a visual representation.

The term “regenerate the prompt sentence information” refers to a process of creating new prompt sentence information by combining structured information with corrected prompt sentence information, such that the new prompt sentence information can be used as input to a generative AI model for image generation.

The server executes a computer program that implements the claimed functions using a combination of general-purpose and specialized hardware. The server includes at least one central processing unit (CPU), a system memory, a non-volatile storage device, a network interface, and optionally a graphics processing unit (GPU) configured for parallel numerical computation. The server runs a server operating system such as a general-purpose UNIX-like system and executes application software implemented, for example, in a high-level programming language. The server communicates with at least one terminal operated by a user via a communication network using a protocol stack including a transport protocol and an application protocol such as HTTP over TLS.

The terminal executes a client program such as a native mobile application or a web browser application. The terminal includes an input interface such as a touchscreen, a display unit such as a liquid crystal or organic light-emitting diode display, a local storage device, and a communication interface. The terminal sends natural language text information authored by the user to the server and receives image data representing a visual representation generated on the basis of the text information.

The user operates the terminal to input text information that describes memories or scenes, such as sentences including descriptions of locations, time periods, and emotional impressions. The user can input, for example, a sentence such as “I spent a fun afternoon at a summer beach with my friends, watching the sunset,” or “A quiet winter night in a small town, with snow falling gently and warm lights from the windows.” The terminal transmits this text information to the server, which stores the text information as structured data and initiates a sequence of language analysis and image generation operations.

The server uses software modules that implement a language analysis technique, including tokenization, part-of-speech tagging, syntactic parsing, semantic role labeling, and emotion analysis. The server loads, into memory, at least one language model implemented as a neural network architecture such as a transformer model. The transformer model includes an embedding layer that maps token identifiers to dense vector representations, multiple layers of self-attention and feedforward units, and an output head adapted for a specific downstream task, such as sequence labeling or text classification. The server performs numerical operations such as matrix multiplications, dot products, softmax operations, and non-linear activation functions on the CPU and/or GPU to compute context-dependent embeddings for each token in the user's text.

The server applies a feature extraction algorithm that maps the context-dependent embeddings to structured attributes representing visual element information. The server identifies tokens or token spans corresponding to scene locations, objects, time expressions, environmental conditions, and affective descriptors. The server assigns each identified token span to an attribute type using a classification head trained on annotated data, where the classification head computes a probability distribution over attribute types and selects the most probable type for each candidate span. The server stores the extracted visual element information as structured information in a data structure such as a record or an object containing fields for location, time, people, objects, mood, and style preferences.

The server further performs emotion state analysis using either a dedicated emotion classification model or an auxiliary head attached to the same transformer backbone. The server computes emotion-type information (for example, joy, sadness, calmness, excitement) and emotion-intensity information (for example, a scalar value between 0 and 1) from the aggregated representation of the text. The server inserts the emotion-type information and emotion-intensity information as attributes into the structured information. In some embodiments, the server maps emotion-intensity information to numerical parameters for later use in controlling color saturation, brightness, or contrast during image post-processing.

The server generates prompt sentence information on the basis of the structured information.

The server uses a template-based generation module and, optionally, a text refinement module that may also be implemented as a transformer model configured for text generation.

The server constructs a prompt sentence by combining outline information of a scene, object information, time-zone information, atmosphere information, and expression-style information in a prescribed order. For example, on the basis of structured information corresponding to a beach scene, the server generates a prompt sentence such as:
“Please draw a semi-realistic illustration of a summer beach in late afternoon, just before sunset, showing a group of friends having fun and relaxing together, with warm orange sunlight reflecting on the waves.”

On the basis of structured information corresponding to a winter town scene, the server generates a prompt sentence such as:
“Please generate an illustration of a quiet winter night in a small town, with snow falling gently, warm yellow lights shining from the windows, and a calm, peaceful atmosphere.”

The server controls the length and complexity of the prompt sentence to comply with limitations of the generative AI model and to reduce ambiguity. The server computes a token length for the prompt sentence, compares it with a predetermined maximum, and applies truncation or simplification rules if necessary. The server can also remove redundant phrases or low-information adjectives using a scoring function that evaluates each phrase's contribution to attribute coverage.

The server then interacts with a generative AI model for image generation, implemented, for example, as a diffusion-based neural network or an alternative generative architecture such as a generative adversarial network. In a diffusion-based implementation, the server supplies the prompt sentence as conditioning information to a text encoder component of the model that converts tokens into an embedding sequence. The server passes this embedding sequence, together with a random noise tensor initialized in image space, to a denoising network composed of multiple convolutional and attention layers. The denoising network iteratively refines the noise tensor through a fixed number of time steps, guided by the prompt embedding, to produce an image tensor that encodes a visual representation matching the semantics of the prompt sentence.

The server runs the generative AI model on the GPU to perform highly parallel numerical computations, including convolution operations, normalization operations, and non-linear activations such as rectified linear unit or similar functions. The server sets a guidance scale parameter and a number of denoising steps based on the complexity of the scene and the emotion-intensity information. For example, the server can increase guidance scale and denoising steps for scenes requiring detailed textures and nuanced lighting, thus improving image fidelity and consistency with the prompt.

The server receives the image tensor output from the generative AI model and converts it into an image file in a format such as a raster format. The server then applies an image processing technique using an image processing library implemented on the CPU and optionally accelerated by the GPU. The server adjusts resolution information by resampling the image to match target display or print dimensions, adjusts tone information by applying gamma correction and color balance operations, and adjusts sharpness information by applying convolution-based sharpening filters. The server selects specific parameter values for these operations based on the intended output medium, for example, a high pixel density for print media and a specific resolution and aspect ratio for use as a background display on a terminal display.

The server converts the processed image into output format information, including file type, resolution, color space, and compression settings appropriate for the terminal or a printing device. The server then provides the image to the terminal, where the terminal displays the image as background display information or forwards it to a printer. When the image is used as a background for an electronic display apparatus, the terminal interacts with an operating system interface to set the generated image as a wallpaper or lock-screen image, thereby controlling the content displayed on a physical display. When the image is used as print image information, the terminal communicates with a printer to transfer the image and cause a printing engine to deposit toner or ink onto a print medium.

The server supports prompt refinement and regeneration in a manner that improves computational efficiency and image consistency. When the user views a generated image on the terminal, the user can request modification by editing the prompt sentence displayed in association with the image. The user may modify, for example, a prompt sentence to read:
“Please draw a photorealistic image of a summer beach at sunset, with vivid colors and detailed waves, focusing on the silhouettes of friends laughing together.”

The terminal sends the corrected prompt sentence information back to the server together with an identifier of the previously stored structured information. The server does not repeat the full language analysis and feature extraction process for the original text. Instead, the server accesses the stored structured information and combines it with the corrected prompt sentence information using a rule-based integration algorithm. The server ensures that essential attributes such as location and time context are preserved while updated stylistic or compositional instructions from the corrected prompt sentence are incorporated. This reuse of structured information reduces processing time and computation required for subsequent generations and maintains consistency across different images derived from the same underlying memory.

The server then uses the regenerated prompt sentence information as new input to the generative AI model, executes the same image generation and post-processing pipeline, and provides the regenerated visual representation to the terminal. Because the structured information is reused and only the prompt-level instructions are modified, the server requires fewer numerical operations in the language analysis stage and can allocate more GPU time to improving image quality, thereby increasing overall throughput and reducing latency.

The server stores the structured information, prompt sentences, and generated image identifiers in a data management structure such as a relational table or a key-value store. The server associates each record with a user identifier and a timestamp, allowing efficient retrieval and reuse. This structured storage improves data management compared with ad hoc logging of raw text and images and enables scalable operation when many users concurrently request image generation.

The server improves computer technology beyond mere automation of human mental tasks by introducing non-conventional data structures and processing flows between text analysis and image generation. In particular, the server enforces a separation between raw text information, structured information, and prompt sentence information. The server applies specific algorithms to map context-dependent embeddings to attribute-level structured information, and then uses this structured information to generate constrained prompt sentences. This decomposition reduces the dimensionality and variability seen by the generative AI model, leading to more stable convergence in the denoising iterations and reduced need for repeated trial generations. The technical effect is improved computational efficiency in GPU utilization, reduced network bandwidth for repeated requests, and improved predictability of output distributions for a given text input.

The server also improves accuracy in reflecting user emotion in the visual output by quantifying emotion-type and emotion-intensity information and mapping these values to both textual descriptions in the prompt and numerical parameters in post-processing. For example, higher emotion-intensity values corresponding to joy can lead the server to increase color saturation and brightness in the processed image, whereas lower intensity or negative emotion types can lead to reduced saturation or cooler color tones. This rule-based mapping from emotion attributes to processing parameters is implemented in the server and is not achievable by manual editing with the same consistency and speed, thereby providing a technical improvement in the control of image post-processing.

The server can implement multiple alternative embodiments of the generative AI model and language analysis modules. In one embodiment, the server uses a transformer-based encoder-only architecture for language analysis and a diffusion-based generative model for images. In another embodiment, the server uses an encoder-decoder transformer for generating prompt sentences directly as a conditional generation task, while still maintaining separate structured information for attribute-level control and logging. In yet another embodiment, the server applies a hybrid approach in which rule-based extraction of dates, locations, and person references is combined with neural network-based extraction of more subtle attributes such as mood and atmosphere.

The server may employ different training methods for the neural network components, including supervised learning on annotated corpora for attribute extraction, supervised or reinforcement learning for emotion classification, and standard training procedures for generative models, such as minimizing a loss function that measures divergence between model-generated samples and training images. During training of the generative model, the server or an associated training platform minimizes an objective function such as a variational bound or a mean-squared error in the denoising steps, updating the model's weights using gradient descent or a variant such as Adam. Although training is typically performed offline, the architectural choices and learned parameters directly influence the runtime performance and quality of image generation executed by the server.

The server can also implement data augmentation techniques during model training, such as random cropping, color jittering, and geometric transformations of training images, to improve robustness and generalization. The server uses these techniques to obtain a model that produces high-quality images across a wide range of prompt sentences, thereby reducing the likelihood of artifacts and increasing the fidelity of generated visuals to the structured attributes extracted from text.

The terminal can be implemented in various forms, including a smartphone, a tablet, a notebook computer, or a stationary display device. The terminal may provide different user interfaces for different use cases, such as a gallery interface that lists previously generated images with their associated prompt sentences and timestamps. The user can select any image and prompt pair and request regeneration with modified parameters. The terminal then sends only the modified prompt sentence or a small set of modifications to the server, thereby reducing the volume of transmitted data and lowering communication load on the network.

The described embodiments illustrate how the server, the terminal, and the user cooperate to transform natural language descriptions into visual representations using a generative AI model and structured prompt sentence information. By specifying non-conventional data structures, neural network architectures, and rule-based mappings between extracted attributes and model or post-processing parameters, the system provides technical improvements in processing speed, output accuracy, and resource utilization, and enables reliable control of physical display and printing devices based on computationally derived image data.

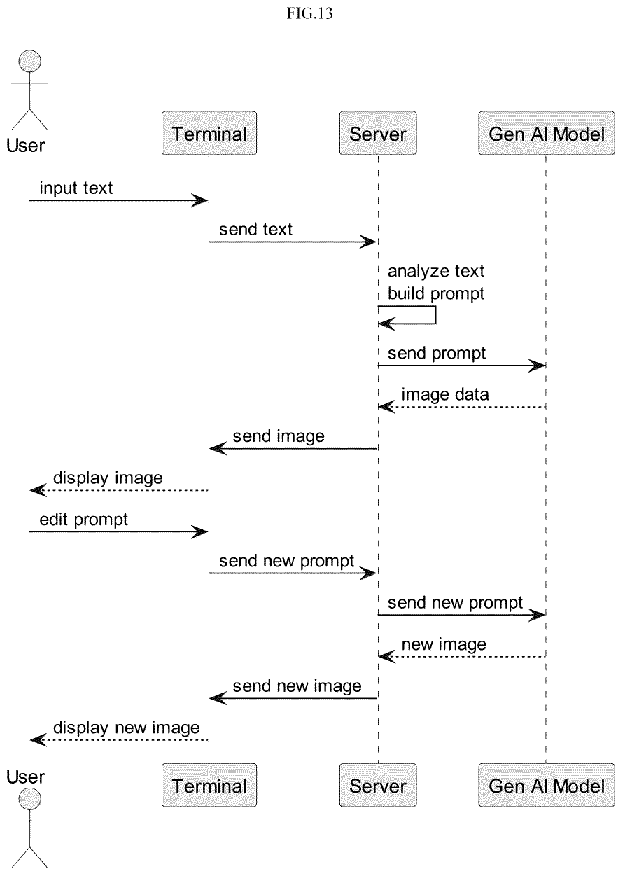

The following describes the processing flow using FIG. 13.

### Step 1:

The user operates the terminal to launch a client application and opens a text input screen.

The user inputs natural language text information describing a memory or scene, such as “I spent a fun afternoon at a summer beach with my friends, watching the sunset.” The terminal receives the text as a character string and validates that the string is not empty and within a preset maximum length. The terminal converts the text and a user identifier into a request object and sets this request object as the output of Step 1. The input of Step 1 is user keystrokes or touch input, and the output is a structured request object containing the raw text and metadata.

### Step 2:

The terminal transmits the request object to the server over a network using a communication protocol. The terminal serializes the request object into a message format and sends it via a secure connection. The server receives the message and parses the serialized data to restore the request object. The input of Step 2 is the structured request object at the terminal, and the output is the same request object reconstructed and stored in server memory.

### Step 3:

The server stores the received text information and associated metadata into a storage subsystem. The server writes the text information, the user identifier, and a timestamp into a persistent data structure. The server may assign a unique request identifier and attach it to the record. The server performs basic normalization such as trimming whitespace and normalizing character encoding. The input of Step 3 is the request object in server memory, and the output is a database or storage record that persists the normalized text and identifiers.

### Step 4:

The server applies a language analysis technique to the normalized text. The server invokes a tokenizer to split the text into tokens and maps each token to an integer identifier using a vocabulary. The server then loads a language model and forwards the token identifiers and position information to the model. The model performs numerical computation, including embedding lookup, matrix multiplication, and application of non-linear activation functions, to output context-dependent vector representations for the tokens. The input of Step 4 is the normalized text string, and the output is a sequence of numerical vectors representing token embeddings with contextual information.

### Step 5:

The server extracts visual element information and emotion state information from the contextual embeddings. The server applies one or more classifier heads that take the embeddings as input and compute probabilities for categories such as location, object, time expression, and emotional descriptor. The server selects the most probable labels and identifies spans of tokens belonging to each label type. The server further applies an emotion classifier that processes an aggregated embedding of the entire sequence and produces emotion-type and emotion-intensity values. The input of Step 5 is the sequence of contextual embeddings, and the output is structured information including lists of locations, objects, time expressions, scene descriptions, and quantitative emotion attributes.

### Step 6:

The server organizes the extracted elements into a structured data object. The server creates fields such as “scene_outline,” “objects,” “time_zone,” “atmosphere,” and “style,” and assigns the extracted values to these fields. The server includes emotion-type and emotion-intensity information in the “atmosphere” field or associated subfields. The server may apply rule-based normalization, such as unifying synonymous terms or converting time expressions into canonical forms. The input of Step 6 is the raw extracted labels and spans, and the output is a structured information object with explicit attribute fields suitable for subsequent processing.

### Step 7:

The server generates a prompt sentence based on the structured information. The server uses a template or pattern to assemble a natural language description that includes the scene outline, the objects, the time-zone information, the atmosphere, and the expression style. The server concatenates text fragments, inserts attribute values, and adjusts grammar and word order. For example, the server may output a prompt sentence such as “Please draw a semi-realistic illustration of a summer beach in late afternoon, just before sunset, showing a group of friends having fun and relaxing together, with warm orange sunlight reflecting on the waves.” The input of Step 7 is the structured information object, and the output is a complete prompt sentence string.

### Step 8:

The server optimizes and validates the generated prompt sentence. The server calculates the token length of the prompt sentence using the tokenizer of the target generative AI model and compares this length to a predefined maximum. If the length exceeds the maximum, the server removes less important adjectives, merges similar phrases, or replaces long phrases with shorter equivalents according to predefined rules. The server checks for forbidden terms or ambiguous expressions and modifies them if necessary. The input of Step 8 is the initial prompt sentence, and the output is a validated and possibly shortened prompt sentence that is compatible with the generative AI model.

### Step 9:

The server constructs a generation request for the generative AI model. The server creates a data structure containing the validated prompt sentence, optional negative conditions, image size parameters, and guidance scale or quality parameters. The server encodes this data structure into the format expected by the generative AI model, which may be an internal procedure call or an external service request. The input of Step 9 is the validated prompt sentence together with configuration settings, and the output is a formatted generation request object ready to be submitted to the generative AI model.

### Step 10:

The server executes the generative AI model using the generation request as input. The server passes the prompt sentence to a text encoder component that computes a sequence of embeddings, and then conditions an image-generation network such as a diffusion network on these embeddings. The server iteratively updates an image tensor by performing repeated numerical operations including convolutions, attention computations, and non-linear activations over multiple time steps. The server stops the iterations when a predetermined number of steps is reached or a convergence condition is satisfied. The input of Step 10 is the generation request object, and the output is an image tensor or raster image data representing a visual representation corresponding to the prompt sentence.

### Step 11:

The server converts and post-processes the image data. The server transforms the image tensor into an image file in a chosen color space and format. The server resizes the image to the required resolution, adjusts contrast and brightness, and applies sharpening or smoothing filters as needed. The server selects parameter values based on whether the image is targeted for background display on a terminal or for printing on a physical medium. The input of Step 11 is the raw image tensor or high-resolution image data, and the output is finalized image data in a standard graphics format with properties adapted to the intended output medium.

### Step 12:

The server generates output format information and stores references to the generated image.

The server assigns an identifier to the image, records the identifier, the prompt sentence, and the structured information in a storage system, and may generate a network-accessible location for the image file. The server packages the image or its reference in a response structure. The input of Step 12 is the finalized image data and associated parameters, and the output is a response object containing the image data or a reference, along with metadata such as image size and generation time.

### Step 13:

The server transmits the response object to the terminal over the network. The server serializes the response object and sends it using the appropriate protocol. The terminal receives the message, deserializes it, and reconstructs the image data and metadata. The input of Step 13 is the response object in server memory, and the output is the corresponding response structure present in terminal memory, including reconstructable image data.

### Step 14:

The terminal displays the visual representation and associated prompt sentence. The terminal decodes the image data, loads it into a display buffer, and renders it on the display device.

The terminal places the prompt sentence near the image so that the user can see how the scene was described. The terminal adjusts the layout according to screen size and orientation. The input of Step 14 is the image data and prompt sentence from the response, and the output is a rendered display state that presents the visual representation and text to the user.

### Step 15:

The user evaluates the displayed image and selects a utilization option. The user may choose to set the image as device background, save the image, or initiate printing. The terminal captures the user's selection and, in the case of background usage, instructs the operating system to register the image as wallpaper or lock-screen background, updating system settings. In the case of printing, the terminal sends the image and print parameters to a printing device. The input of Step 15 is user interaction with the displayed interface, and the output is a change in device state (background image) or printer state (print job initiated).

### Step 16:

The user may request modification and regeneration of the image. The user edits the prompt sentence displayed on the terminal, for example changing it to “Please draw a photorealistic image of a summer beach at sunset, with vivid colors and detailed waves, focusing on the silhouettes of friends laughing together.” The terminal captures the edited prompt sentence and associates it with the identifier of the original request. The terminal sends this corrected prompt sentence and identifier to the server. The input of Step 16 is user-edited prompt text, and the output is a regeneration request object transmitted to the server.

### Step 17:

The server processes the regeneration request using stored structured information. The server retrieves the structured information associated with the original request identifier from storage and combines it with the corrected prompt sentence according to predefined rules.

The server may override stylistic attributes and emphasis indicated in the corrected prompt while retaining core attributes such as location and time. The server constructs a new prompt sentence if necessary or directly validates the corrected one, and then repeats the generation, post-processing, and response transmission steps. The input of Step 17 is the regeneration request containing the corrected prompt and the identifier, and the output is a new image data set and response structure produced with reduced language analysis overhead due to reuse of structured information.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented content generation systems that utilize machine learning models or generative artificial intelligence models typically accept a short, manually written prompt and directly generate an image or other media based on that prompt. Such systems suffer from several technical limitations.

First, the quality and controllability of the generated visual content are highly dependent on the user's ability to craft an appropriate prompt, which is a non-trivial task for non-expert users. As a result, the mapping from a user's natural language description of a memory or emotion to a machine-interpretable prompt is inconsistent, leading to unstable and often unsatisfactory output. This imposes a cognitive and interaction burden on the user interface and prevents the computing system from robustly exploiting the capabilities of the generative artificial intelligence model.

Second, conventional systems do not perform structured analysis of input language to extract scene-defining components, such as object information, environment information, and time information, nor do they compute a quantitative emotion profile that reflects emotion type and emotion intensity. Because these systems treat the input text as an opaque string, the internal representation used by the computing hardware is not optimized for controlling generative model behavior. This leads to inefficient use of processing resources and limits the reproducibility and precision of visual outputs relative to the input data.

Third, many existing systems lack an integrated pipeline that converts user memories and emotions into multiple candidate prompts, evaluates corresponding generated outputs, and performs systematic post-processing for a variety of target formats, such as wallpaper, printed media, electronic content, and virtual-reality content. Without such an integrated pipeline, the computing device must rely on separate manual tools for resolution conversion, aspect-ratio adaptation, and content structuring, which introduces additional data transfers, redundant processing, and latency.

Fourth, conventional systems provide limited support for generating structured visual stories or immersive virtual-space content from natural language descriptions. In particular, they do not automatically compute environment configuration information such as viewpoint position, line-of-sight direction, and object arrangement in a three-dimensional space, nor do they map generated visual representation data into a virtual environment based on such configuration. This results in fragmented processing flows and suboptimal use of graphics processing resources when producing virtual-reality experience content.

Accordingly, there is a need for an improved computer-implemented system and processing method that: (i) systematically analyzes user language information and derives structured visual element information and emotion information; (ii) automatically composes prompt sentences for a generative artificial intelligence model based on such structured information; (iii) efficiently generates and post-processes visual representation data adapted to diverse output formats; and (iv) in certain embodiments, generates environment configuration information for virtual spaces and maps visual representation data into a three-dimensional environment. By addressing these issues at the level of the system architecture and data processing flow, the invention aims to improve the functioning of the computer itself in generating, controlling, and delivering personalized visual content.

The specific processing by the specific processing unit 290 of the data processing device 12 in Application Example 2 is realized by the following means.

The present invention provides a server comprising a processor configured to receive language information as input from a user via a terminal and analyze the language information by using a natural language processing technique to extract visual element information including object information, environment information, and time information that constitute a scene, execute emotion analysis processing on the language information and the visual element information to identify emotion information including an emotion type and an emotion intensity, automatically generate a prompt sentence as an instruction sentence including constituent elements of the scene, an atmosphere, and an expression style on the basis of the visual element information and the emotion information, input the prompt sentence and generation condition information into a generative artificial intelligence model and cause the generative artificial intelligence model to generate visual representation data including image data or video data corresponding to the prompt sentence by numerical computation processing, configure the visual representation data as at least one of a single image, a continuous story including a plurality of images, and a virtual-space visual content, perform post-processing to convert a resolution, a viewing angle, and an aspect ratio of the visual representation data in accordance with an output format, and transmit post-processed visual representation data to an output device including at least one of a display device, a printing device, and a storage device so as to provide the post-processed visual representation data as at least one of wallpaper, a printed medium, electronic content, and virtual-reality content. This enables the computing system to internally transform unstructured user language information into structured scene and emotion representations, automatically construct optimized prompt sentences for a generative artificial intelligence model, efficiently generate and adapt visual representation data to multiple output targets, and, in certain embodiments, produce virtual-space content with computed environment configuration information, thereby improving the technical performance, controllability, and reliability of computer-based generative content processing.

The term “language information” refers to character data or linguistic data provided by a user, including natural language sentences, phrases, or keywords, which describe a scene, memory, situation, or emotion and are suitable for analysis by a natural language processing technique.

The term “terminal” refers to an electronic device operated by a user to input language information and to receive visual representation data, including but not limited to a portable information processing device, a head-mounted display, a personal computer, or any other user interface device capable of network communication with a server.

The term “natural language processing technique” refers to a computerized processing technique for analyzing human-readable language, including at least one of tokenization, part-of-speech tagging, syntactic parsing, semantic analysis, and named-entity recognition, in order to extract structured information from language information.

The term “visual element information” refers to structured data representing visual aspects of a scene derived from language information, including at least object information, environment information, and time information, that can be used to define or control visual content generated by a generative artificial intelligence model.

The term “object information” refers to a subset of visual element information that specifies tangible or visible entities in a scene, such as persons, animals, artifacts, or natural objects, which can be depicted as components of an image or video.

The term “environment information” refers to a subset of visual element information that specifies contextual characteristics of a scene, including at least location, background, weather, lighting conditions, and overall setting, which influence the appearance and atmosphere of generated visual content.

The term “time information” refers to a subset of visual element information that specifies temporal aspects of a scene, including at least time of day, season, or historical period, which affect the visual appearance, lighting, or contextual interpretation of generated visual content.

The term “emotion information” refers to structured data representing an emotional state inferred from language information and/or visual element information, including at least an emotion type and an emotion intensity that are used to control style, color tone, atmosphere, or composition of visual representation data.

The term “emotion type” refers to a category label indicating a class of emotion, such as happiness, sadness, nostalgia, calmness, or excitement, which is identified by an emotion analysis process and used as a control parameter in visual content generation.

The term “emotion intensity” refers to a quantitative value or scaled level that indicates the strength or degree of a detected emotion type, and which is used to modulate one or more visual parameters such as saturation, contrast, brightness, or stylistic emphasis.

The term “emotion analysis processing” refers to a computerized procedure for detecting and quantifying emotions from language information and/or visual element information, using at least one of rule-based analysis, statistical modeling, or machine learning, in order to output emotion information.

The term “prompt sentence” refers to a machine-interpretable instruction sentence generated automatically on the basis of visual element information and emotion information, and used as an input directive to a generative artificial intelligence model for producing visual representation data.

The term “instruction sentence” refers to a sentence or sequence of tokens that encodes constraints and desired characteristics of target visual content, including scene composition, atmosphere, and expression style, and that is supplied to a generative artificial intelligence model as a control input.

The term “generation condition information” refers to auxiliary parameters provided to a generative artificial intelligence model together with a prompt sentence, including at least image size, number of generation steps, randomness control values, and style parameters, which influence how the model generates visual representation data.

The term “generative artificial intelligence model” refers to a computational model implemented by one or more processors that, in response to a prompt sentence and generation condition information, performs numerical computation processing such as matrix operations, probabilistic sampling, or iterative denoising, to generate novel data including at least image data or video data.

The term “visual representation data” refers to digital data representing visual content generated by a generative artificial intelligence model, including at least still image data and moving image data, which depict a scene corresponding to a prompt sentence and are suitable for display, printing, or storage.

The term “single image” refers to visual representation data consisting of a single frame or picture that visually represents a scene, and that can be used independently as wallpaper, a printed medium, or an electronic image.

The term “continuous story” refers to a set of visual representation data including a plurality of images that are arranged in a defined order to represent temporal progression, narrative structure, or multiple viewpoints of a scene or memory.

The term “virtual-space visual content” refers to visual representation data that is configured for use in a virtual environment, including at least panoramic images, environment textures, or spatially arranged assets, which can be presented within a three-dimensional space to provide an immersive experience.

The term “post-processing” refers to a processing stage applied after initial generation of visual representation data, including at least resolution conversion, viewing angle adjustment, aspect ratio conversion, color or tone adjustment, and compositing operations, in order to adapt the visual representation data to a target output format or device capability.

The term “output device” refers to a hardware device or a combination of hardware and software that receives visual representation data from a server and presents or records the data, including at least a display device, a printing device, and a storage device.

The term “display device” refers to an apparatus for visually presenting image data or video data to a user, including at least a flat-panel display, a head-mounted display, a projection display, or any other electronic visual display.

The term “printing device” refers to an apparatus that converts digital image data into a physical printed medium by depositing ink, toner, or other marking material onto paper, film, or another substrate.

The term “storage device” refers to an apparatus or subsystem configured to record and retain digital data, including at least semiconductor memory, magnetic storage, optical storage, or network-accessible storage.

The term “wallpaper” refers to visual representation data formatted for use as a background image on an electronic display of a terminal or other device, having a resolution and aspect ratio adjusted to the characteristics of the display.

The term “printed medium” refers to a physical substrate such as paper, card, or film on which visual representation data has been recorded by a printing device, and which can be used as a poster, booklet, or other tangible artifact.

The term “electronic content” refers to digital content comprising visual representation data that is stored and accessed electronically, including at least image files, video files, or packaged multimedia data suitable for display or distribution over a network.

The term “virtual-reality content” refers to electronic content in which visual representation data is configured to be presented in a virtual environment using a virtual-reality interface, allowing a user to experience immersion through head tracking, stereoscopic display, or other virtual-reality techniques.

The term “environment configuration information” refers to structured data that defines parameters of a three-dimensional environment, including at least viewpoint position information, line-of-sight direction information, and arrangement information of objects, used to place and orient visual representation data in a virtual space.

The term “viewpoint position information” refers to data specifying a location of a virtual camera or observer within a three-dimensional coordinate system, which determines from where a scene is rendered in virtual-space visual content.

The term “line-of-sight direction information” refers to data specifying an orientation or direction in which a virtual camera or observer is directed within a three-dimensional space, which affects what part of a virtual scene is visible.

The term “arrangement information” refers to data defining the positions, orientations, and optionally sizes of one or more objects or visual elements within a three-dimensional space, used to compose a spatial arrangement in virtual-space visual content.

The term “three-dimensional space” refers to a coordinate space having at least three axes, used in computer graphics to represent positions and orientations of visual elements for rendering scenes with depth and perspective.

The term “virtual-reality experience content” refers to virtual-reality content that has been configured together with environment configuration information so that a user, by operating a virtual-reality device, can perceive and interact with the scene as if present within a three-dimensional environment.

The term “processor” refers to one or more hardware elements capable of executing machine-readable instructions, including at least a central processing unit, a graphics processing unit, or a specialized accelerator, configured to perform the data analysis, prompt generation, model inference, and post-processing described in the claims.

In the following embodiments, a server, a terminal, and a user cooperate to implement the claimed system. The embodiments are illustrative and not limiting, and various modifications may be made without departing from the scope of the claims.

### 1. System Architecture and Hardware Configuration

Server includes one or more processors, one or more memories, a network interface, a storage subsystem, and, in some embodiments, a dedicated graphics processing unit. Server is implemented by a general-purpose computing platform or a cloud-computing node. The processor includes at least a central processing unit and may further include a graphics processing unit or an accelerator specialized for numerical computation.

Server uses the memory to load program modules implementing natural language processing, emotion analysis, prompt sentence generation, and inference of a generative AI model. Server uses the storage subsystem, such as a magnetic disk device or a solid-state storage device, to persist user inputs, intermediate feature representations, prompt sentences, visual representation data, and environment configuration information.

Terminal includes a display device, an input interface, a communication interface, a local processor, and a local memory. Terminal is implemented by a portable information processing device, a head-mounted display, a personal computer, or a similar communication device. Terminal executes an application or a browser that communicates with server via a communication network.

User operates terminal to supply language information and to browse and utilize visual representation data. User is not required to provide structured prompts; instead, user inputs free-form natural language, and server performs the structuring and optimization of prompt sentences.

### 2. Software Modules and Data Structures on the Server

Server executes an operating system and a plurality of application modules. In one embodiment, server uses a programming language runtime such as a general-purpose scripting or compiled language environment. Server further uses:
A natural language processing library, such as a pipeline including tokenization, part-of-speech tagging, dependency parsing, and named-entity recognition, functionally equivalent to frameworks like spaCy, NLTK, or a transformer-based language model.
An emotion analysis engine implemented by a neural-network classifier or regression model, for example a transformer-based encoder trained on emotion-annotated corpora.
A generative AI model for visual content, such as a diffusion-based model functionally similar to Stable Diffusion or a text-to-image transformer model.
Image processing utilities functionally similar to libraries such as Pillow or ImageMagick.
Optionally, a three-dimensional graphics engine functionally similar to a game engine to generate virtual-space visual content.

Server defines explicit data structures to represent intermediate results. For example, server stores language information as a character string together with metadata (user identifier, timestamp, language code). Server stores visual element information as a structured object including fields such as:
object_list: an array of canonical object names,
environment_list: an array of environment descriptors,
time_descriptor: a normalized temporal tag,
location_descriptor: a location tag if detectable.

Server stores emotion information as a structure including:
emotion_type: a categorical label,
emotion_intensity: a real-valued score in a continuous range,
auxiliary_scores: optional scores for multiple emotion dimensions.

Server stores a prompt sentence as a text string containing explicit references to objects, environments, and emotional style. Server stores visual representation data in an image format or a video format and may associate that data with a content identifier.

### 3. Natural Language Analysis and Extraction of Visual Elements

Server uses the natural language processing library to perform structured analysis of language information. Server parameterizes the natural language processing pipeline with language-specific models so that part-of-speech tags, syntactic dependencies, and named entities are produced consistently.

Server uses rule-based extractors and learned classifiers together. For example, server applies:
A rule-based pattern set that maps certain syntactic constructions to candidate scene elements (e.g., noun phrases describing physical objects or locations).
A terminology dictionary that maps colloquial expressions into canonical object names and environment descriptors.
A statistical classifier that rejects non-visual terms based on semantic embeddings.

By transforming unstructured character sequences into typed visual element information, server improves the internal representation fed to the generative AI model. This structured representation enables server to control the generative AI model more precisely than a direct, unprocessed text prompt. As a result, the system reduces variance in output quality and improves reproducibility of generated content, which constitutes a technical improvement in computer-based content generation.

### 4. Emotion Analysis and Construction of Emotion Information

Server uses an emotion analysis engine whose core is a neural network classifier. In one embodiment, server uses a transformer-based encoder with multiple self-attention layers and feed-forward layers. The model receives tokenized language information and optional visual element information as inputs. Server embeds the tokens into a vector space, propagates them through self-attention layers that capture long-range dependencies, aggregates the sequence into a fixed-length representation by pooling, and applies a final classification layer that outputs emotion scores.

Server trains this model by supervised learning on a corpus of text annotated with emotion labels and intensity scores. Server uses a loss function such as cross-entropy loss for categorical emotion-type prediction and mean squared error for emotion-intensity regression.

Server updates model weights by gradient descent with back-propagation. Server optionally uses data augmentation techniques such as synonym replacement or paraphrasing to increase robustness.

By computing emotion_type and emotion_intensity, server creates emotion information that is not merely a label, but a continuous control signal for the generative AI model. Server uses emotion_intensity to scale parameters such as color saturation, contrast, or stylistic exaggeration in post-processing. This continuous, machine-usable representation allows the system to implement parameterized visual styles that are not realistically achievable by manual per-case tuning and thus improves computer control of style rendering.

### 5. Automatic Generation of Prompt Sentences

Server uses a prompt generator module that constructs a prompt sentence from visual element information and emotion information. Server combines:
Template-based rules, which specify sentence skeletons depending on emotion_type and content category.
A language model, which fills in descriptive phrases and ensures fluency.

For example, server may select a template such as:
“A [emotion_adjective] [environment_description] with [object_list], in a [style] style.”

Server then inserts expressions derived from visual element information and emotion information. When emotion_type is “nostalgic” and emotion_intensity is high, server chooses an adjective such as “nostalgic” and a style descriptor such as “soft, warm-toned illustration”. When environment_list includes “summer festival” and “night sky” and object_list includes “fireworks” and “food stalls”, server creates a prompt sentence such as:
“A nostalgic summer festival at night in a small town street, with fireworks in the dark sky and rows of glowing food stalls, in a soft, warm-toned illustration style.”

Server may also generate alternative prompt sentences, for example:
“Please draw a nostalgic summer festival at night, with bright fireworks, food stalls, and people wearing traditional clothing, in a gentle, warm color palette.”
“Create an artwork of a happy family trip to a summer beach, with a bright blue sea, white sandy beach, and children playing under a shining sun, in a cheerful and colorful style.”

By enforcing a specific mapping from structured features to prompt components, server reduces ambiguity and enforces non-standard, machine-friendly prompt structures. This is not simply automating a human writing task, because server encodes structural constraints that are optimized for the downstream generative AI model, which a human user would not normally apply consistently. This structured prompt generation reduces trial-and-error interactions, lowers the number of generative runs required, and thereby reduces computational load and network traffic in serving content.

### 6. Generative AI Model Structure and Operation

Server deploys a generative AI model that converts prompt sentences and generation condition information into visual representation data. In one embodiment, server uses a diffusion-based generative model consisting of:
A text encoder that converts the prompt sentence into a sequence of embeddings.
A conditional denoising network that repeatedly refines a noise tensor toward an image conditioned on the embeddings.
A decoder that transforms a latent representation into a pixel-space image.

Server parameterizes the diffusion process with a fixed number of denoising steps. For each step, the generative AI model performs numerical computations, including large matrix multiplications and non-linear activation operations on the graphics processing unit. Server adjusts a guidance scale parameter that balances adherence to the prompt sentence versus diversity in output.

In an alternative embodiment, server uses a transformer-based generative model that autoregressively predicts visual tokens given text tokens and previously generated visual tokens. The model architecture uses multiple layers of multi-head self-attention and cross-attention between text and visual streams. The training uses maximum-likelihood estimation with teacher forcing and a cross-entropy loss function.

In both embodiments, server controls the model with generation condition information, such as output resolution, aspect ratio, sampling algorithm choice, and random seed. Server selects these conditions based on visual element information and output format requirements.

By combining structured prompt sentences with model-specific generation parameters, server steers the generative AI model in a way that significantly improves output consistency and reduces invalid or irrelevant images. This improvement manifests in a lower rate of generation retries and reduces energy consumption on the graphics processing unit per successfully accepted output, which is a technical effect in the operation of the computing hardware.

### 7. Post-Processing, Format Adaptation, and Technical Effects

Server uses image processing modules to perform post-processing of visual representation data. Server applies operations such as:
Resolution scaling: resampling the image using interpolation algorithms optimized for edge preservation.
Aspect ratio conversion: cropping or padding with content-aware techniques to avoid distortion of key objects.
Color adjustment: re-mapping color curves to emphasize emotion_intensity (e.g., increasing warmth for nostalgic scenes, enhancing vibrancy for happy scenes).
Compression parameter tuning: balancing file size and visual fidelity for different terminals.

Server stores post-processed visual representation data in multiple variants corresponding to use cases such as wallpaper, printed medium, electronic content, or virtual-reality content. Because server uses structured feature information and emotion information to guide cropping and scaling (for example, keeping important objects within the frame), server reduces the risk of essential objects being cut off. This reduces the need for manual corrections and decreases overall data traffic and re-generation cycles in a multi-user environment, which leads to lower network and storage consumption.

### 8. Virtual-Space Visual Content and Environment Configuration

In some embodiments, server generates virtual-space visual content. Server derives environment configuration information, including a viewpoint position, a line-of-sight direction, and arrangement information, from visual element information and emotion information.

Server maps objects into a three-dimensional coordinate system. For example, when visual element information includes “sea”, “beach”, and “family”, server places a plane representing sand in the foreground, a plane representing water at a lower elevation, and a sky dome representing the sky. Server positions virtual cameras at positions that reflect the emotion_type. For “nostalgic”, server may select a slightly elevated viewpoint with a gentle tilt to create a contemplative perspective. Server records viewpoint position information and line-of-sight direction information accordingly.

Server then maps two-dimensional textures derived from visual representation data onto three-dimensional surfaces, or directly generates three-dimensional shaders guided by the same feature data. By packaging this content in a format suitable for a head-mounted display, server enables terminal to present a virtual-reality experience. The mapping uses non-trivial coordinate transformations and shader parameterization that are automatically derived from structured features rather than from hand-authored scene graphs.

This automatic derivation of three-dimensional layout and camera configuration from language information constitutes more than automation of human design; it allows the graphics subsystem to reuse feature extractions from the natural language processing module to reduce manual modeling steps and to optimize rendering parameters. This leads to improved frame rates and reduced perceived latency on the head-mounted display due to better allocation of rendering resources toward regions identified as important by the feature extraction.

### 9. Example Embodiments

In one example, user inputs at terminal: “My childhood memory of a summer festival in a small town.” User does not specify any formal prompt structure. Terminal transmits this text to server.

Server extracts visual element information: objects (“fireworks”, “food stalls”, “people wearing traditional clothes”), environment (“summer festival”, “night”, “small town street”), and time (“night”). Server then computes emotion information, identifying emotion_type as “nostalgic” with a high emotion_intensity.

Server constructs a prompt sentence:
“A nostalgic summer festival at night in a small town street, with fireworks in the dark sky, rows of glowing food stalls, and people wearing traditional clothing, in a soft, warm-toned illustration style.”

Server supplies this prompt sentence to the generative AI model with conditions specifying a high-resolution square output. The model generates visual representation data depicting the described scene. Server then converts the image into multiple formats, including a wallpaper-sized image and a poster-size printable image, and sends these to terminal. User views the wallpaper and sets it as a background on terminal.

In another example, user inputs: “I spent a happy day at the summer beach with my family.” Server extracts visual element information: objects (“family”, “children”), environment (“summer beach”, “blue sea”, “white sand”), time (“daytime”), and sets emotion_type as “happy”. Server generates a prompt sentence:
“A bright and happy summer beach scene with a vivid blue sea, white sandy beach, and a smiling family with children playing under a shining sun, in a cheerful and colorful style.”

Server feeds this prompt sentence to the generative AI model and generates visual representation data. Server generates a set of images with varying composition and color saturation, structures them as a list, and transmits thumbnails to terminal. User selects one image; server then produces a high-resolution version of the selected image and transmits it.

### 10. Technical Improvements and Non-Conventional Processing

Server uses structured feature extraction, emotion analysis, rule-based prompt synthesis, and model-specific generative parameter control in combination. This combination results in processing flows and data structures that differ from customary generic “input-generate-display” loops.

Because server decomposes language information into explicit visual element information and emotion information, server can:
Filter out non-visual phrases before they reach the generative AI model, reducing noise in the model's conditioning.
Cache feature representations for re-use in later generations, improving throughput.
Perform deterministic selection of prompt components based on discrete rules and continuous intensities, improving reproducibility.

These features, along with the management of multiple prompt sentences and multiple candidate images, allow server to reduce the number of unnecessary generation runs and thereby minimize computation on the generative AI model. This is not merely automating existing user behavior; it adjusts the internal data representation and control logic of the computing system, improving precision, performance, and resource utilization.

Moreover, server reuses analysis outputs from the natural language processing pipeline to drive virtual-space layout and environment configuration. This cross-module reuse enables server to coordinate the text processing subsystem and the three-dimensional graphics subsystem, resulting in optimized camera placement and object positioning without human scene design. This coordination causes technical effects such as more efficient rendering and reduced load on terminal's graphics hardware.

### 11. Variations and Alternative Embodiments

Server may adapt the architecture of the generative AI model. For instance, server may use:
A generative adversarial network with a generator and discriminator network, trained with an adversarial loss and a content-based loss.
A variational autoencoder that encodes scenes into a latent space and decodes them conditioned on text embeddings.

Server may also modify the emotion analysis model to use recurrent networks, convolutional encoders, or hybrid architectures.

Terminal may be implemented as a standalone head-mounted display that directly communicates with server and implements partial inference of lighter models. For example, terminal may cache text embeddings and only request image-space generations for new scenes.

The structure of prompt sentences may be adapted to particular generative AI models. For models that respond to style tags, server may append tags such as “watercolor painting style” or “cinematic lighting”. For models that use explicit negative prompts, server may generate phrases specifying undesired elements, derived from emotion information and application constraints.

These variations remain within the scope of the claims so long as server performs the core operations of analyzing language information, extracting visual element information and emotion information, composing prompt sentences on that basis, controlling a generative AI model, and providing post-processed visual representation data adapted to various output formats and, in some embodiments, virtual-space configurations.

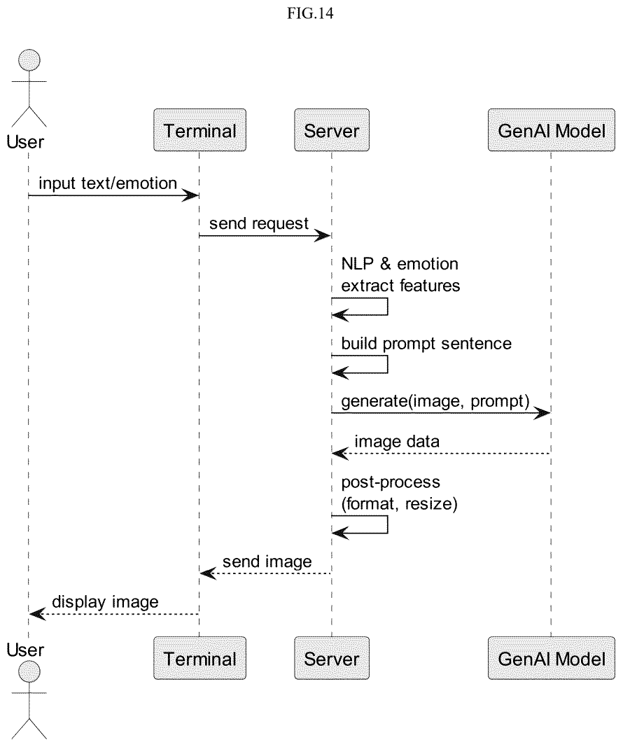

The following describes the processing flow using FIG. 14.

### Step 1:

User operates the terminal and inputs language information describing a memory, scene, or emotion.

User types a free-form natural language sentence, such as “My childhood memory of a summer festival in a small town,” into a text input field on the terminal and optionally selects an emotion label such as “nostalgic.”

The input of Step 1 is raw language information and optional user-selected emotion information.

Terminal converts this input into a structured request object containing fields such as text, optional emotion label, user identifier, and timestamp, and stores it in local memory until transmission.

### Step 2:

Terminal transmits the structured request object to server via a network connection.

Terminal establishes a secure communication channel using a protocol such as HTTPS, serializes the request object into a network message, and sends the message to a predefined application programming interface endpoint on server.

The input of Step 2 is the structured request object generated in Step 1, including text and metadata.

The output of Step 2 is a network message received at server that contains the same structured data, now available for server-side processing.

### Step 3:

Server receives the network message from terminal and stores the raw input data.

Server parses the incoming message, validates that required fields (such as text) are present and within acceptable limits, and assigns an internal request identifier to this processing instance.

Server writes the language information, optional emotion label, user identifier, and timestamp into a persistent storage structure such as a row in a database table.

The input of Step 3 is the structured request object received over the network.

The output of Step 3 is a stored record identified by the internal request identifier and ready to be processed by downstream modules.

### Step 4:

Server analyzes the received language information using a natural language processing technique to extract visual element information.

Server loads a natural language processing pipeline and applies tokenization, part-of-speech tagging, dependency parsing, and named-entity recognition to the language information.

Based on syntactic relations and semantic categories, server identifies candidate phrases corresponding to objects (for example “fireworks,” “food stalls”), environments (for example “summer festival,” “small town street”), and temporal expressions (for example “night”).

Server normalizes these phrases by mapping them to canonical forms using a dictionary or embedding-based similarity computation and constructs a visual element structure that groups the canonical forms into object, environment, time, and location categories.

The input of Step 4 is the raw language information retrieved from the stored record.

The output of Step 4 is visual element information represented as a structured data object associated with the same request identifier.

### Step 5:

Server performs emotion analysis processing on the language information and the visual element information to construct emotion information.

Server feeds tokenized language information, and optionally encoded visual element categories, into an emotion analysis model that has been previously trained as a neural network.

Server computes intermediate feature vectors through layers of the model and obtains output values representing probabilities or scores for one or more emotion types.

Server combines these model-generated scores with any explicit emotion label provided by user by applying a rule such as weighting the explicit label higher or selecting the maximum scoring type.

Server computes a numeric emotion intensity value by scaling model output or by mapping categorical results onto a continuous scale.

The input of Step 5 is the language information and the visual element information produced in Step 4, together with any user-selected emotion label.

The output of Step 5 is emotion information including at least an emotion type and an emotion intensity value linked to the request identifier.

### Step 6:

Server automatically generates a prompt sentence for a generative AI model based on the visual element information and the emotion information.

Server selects a prompt template according to the emotion type and content category (for example “festival,” “beach,” “mountain”) and fills placeholder fields in the template using object lists, environment descriptions, time descriptors, and style expressions derived from the emotion type and intensity.

Server arranges words in a specific order designed to emphasize key objects and environments, inserts stylistic phrases such as “in a soft, warm-toned illustration style” for nostalgic scenes or “in a cheerful and colorful style” for happy scenes, and ensures that the resulting text is grammatically correct by using a language model or syntactic rules.

For example, server may generate a prompt sentence such as: “A nostalgic summer festival at night in a small town street, with fireworks in the dark sky and rows of glowing food stalls, in a soft, warm-toned illustration style.”

The input of Step 6 is the visual element information and emotion information produced by Steps 4 and 5.

The output of Step 6 is a prompt sentence represented as a text string stored in association with the request identifier.

### Step 7:

Server prepares generation condition information and calls the generative AI model with the prompt sentence.

Server determines an output resolution, aspect ratio, number of sampling steps, guidance scale, and random seed, based on target usage (for example wallpaper, poster, or virtual reality) and on properties of terminal.

Server packages the prompt sentence and generation condition information into a model input structure and invokes the generative AI model, which is hosted either locally on server hardware or on a connected computation node.

Server uses graphics processing hardware to execute the generative AI model, performing numerical computations such as repeated matrix multiplications, attention operations, and iterative denoising steps to transform a random initial state into an image representation.

The input of Step 7 is the prompt sentence from Step 6 and the generation condition information determined by server.

The output of Step 7 is visual representation data, such as a latent image tensor or a rendered image file corresponding to the prompt sentence.

### Step 8:

Server decodes and optionally refines the visual representation data produced by the generative AI model.

When the generative AI model outputs a latent representation, server applies a decoder network to transform the latent data into pixel-space image data.

Server optionally runs a quality check using a secondary model or rule set to detect severe artifacts or mismatches with key visual elements, and, if necessary, adjusts generation parameters or retries generation.

Server stores the resulting image data or video data as a visual representation asset linked to the request identifier and records metadata such as the prompt sentence, model configuration, and generation time.

The input of Step 8 is the raw visual representation data from Step 7.

The output of Step 8 is at least one finalized visual representation file or buffer that is visually consistent with the prompt sentence and stored in a retrievable format.

### Step 9:

Server performs post-processing on the visual representation data to adapt it to multiple output formats.

Server loads the image or video into an image-processing module and computes target dimensions and aspect ratios for each required format (for example smartphone wallpaper, printed poster, thumbnail, or panoramic background).

Server applies interpolation algorithms to rescale images, computes cropping regions that preserve central objects indicated by the visual element information, and optionally adds or adjusts margins or padding to achieve the desired aspect ratio without distorting key content.

Server also adjusts color balance, brightness, and contrast according to emotion intensity, for example increasing warmth for nostalgic content or enhancing saturation for happy content.

The input of Step 9 is the finalized visual representation data from Step 8 together with the visual element information, emotion information, and output format specifications.

The output of Step 9 is a set of post-processed visual representation data variants, each variant formatted for a particular use case and stored with a corresponding file identifier or access path.

### Step 10:

Server optionally structures multiple visual representation data items into a continuous story or virtual-space visual content.

When multiple prompt sentences or multiple segments of language information exist for one user session, server orders the corresponding images chronologically or logically and constructs a sequence structure that references the image files and includes optional captions derived from the original language information.

When a virtual-space output is requested, server computes environment configuration information by mapping objects and environments to positions in a three-dimensional coordinate system, assigning viewpoint position and line-of-sight direction consistent with emotion type and narrative focus. Server then combines the image textures and configuration data into a virtual-scene package.

The input of Step 10 is one or more post-processed visual representation data items from Step 9, the visual element information, and the emotion information.

The output of Step 10 is either a structured story object containing a list of images and captions or a virtual-space content package containing visual assets and environment configuration information.

### Step 11:

Server selects appropriate output devices and transmits the prepared content to terminal or another device.

Server determines, based on user preferences and terminal capabilities, which data variants or packages should be delivered, and then generates response messages including download links or directly embedded image or video data.

Server sends these messages via the network interface to terminal and optionally to other output devices such as a printing device or a storage device, updating internal logs to record delivery status.

The input of Step 11 is the set of content variants or packages generated in Steps 9 and 10 and information about available output devices.

The output of Step 11 is one or more network responses containing visual representation data or references thereto, directed to terminal or other devices.

### Step 12:

Terminal receives the transmitted data and presents the visual representation data to user.

Terminal parses the received messages, downloads referenced files if necessary, and stores them in local memory or storage. Terminal renders the images or videos on its display device, presents lists or galleries for multi-image stories, and offers controls for actions such as setting wallpaper, initiating printing through a connected printing device, or launching a virtual-reality viewing mode.

The input of Step 12 is the network responses and associated visual representation data or access links sent from server in Step 11.

The output of Step 12 is a visual presentation on the terminal display and, when user chooses additional actions, one or more commands or requests back to server or to peripheral devices for further content use.

### Step 13:

User interacts with the displayed content and optionally triggers further processing cycles.

User reviews the generated images or stories on terminal, selects preferred items from a list if multiple candidates were provided, and may request high-resolution versions, VR experiences, or additional variations.

Based on user's selection or feedback, terminal sends corresponding instructions to server to regenerate, refine, or store content, thus beginning a new or extended processing cycle starting from an earlier step in the pipeline.

The input of Step 13 is the displayed visual representation data and the user interface elements provided by terminal.

The output of Step 13 is user-generated control input that can cause new requests for language information analysis, new prompt sentence generation, and new runs of the generative AI model, thereby iteratively improving personalization and system performance.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

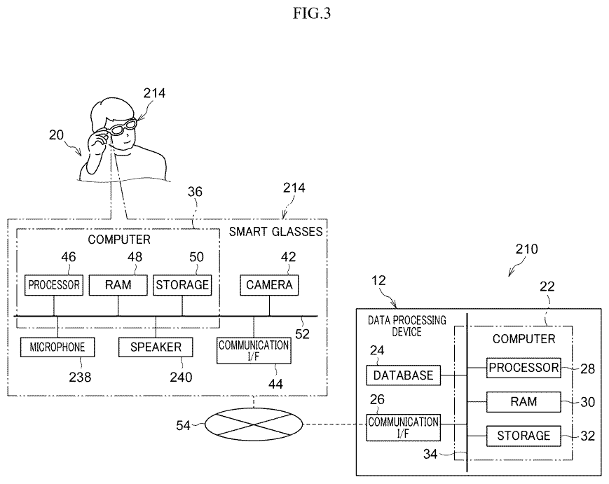

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

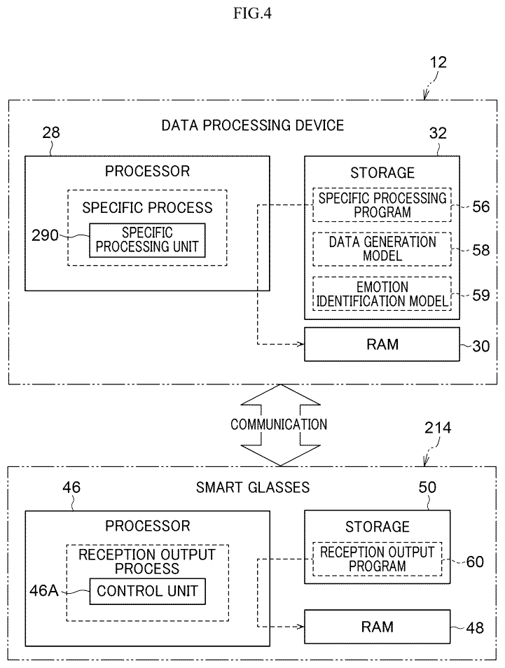

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

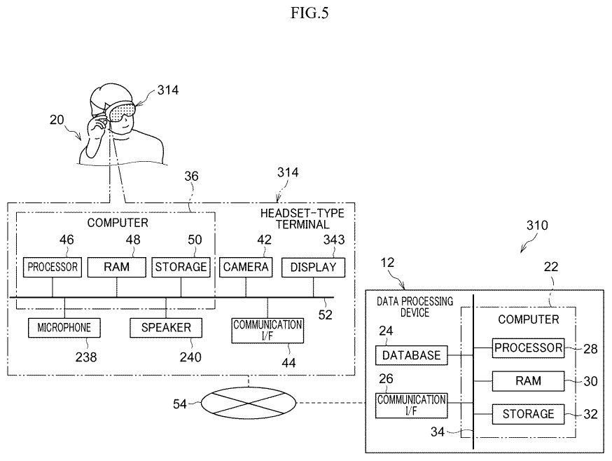

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

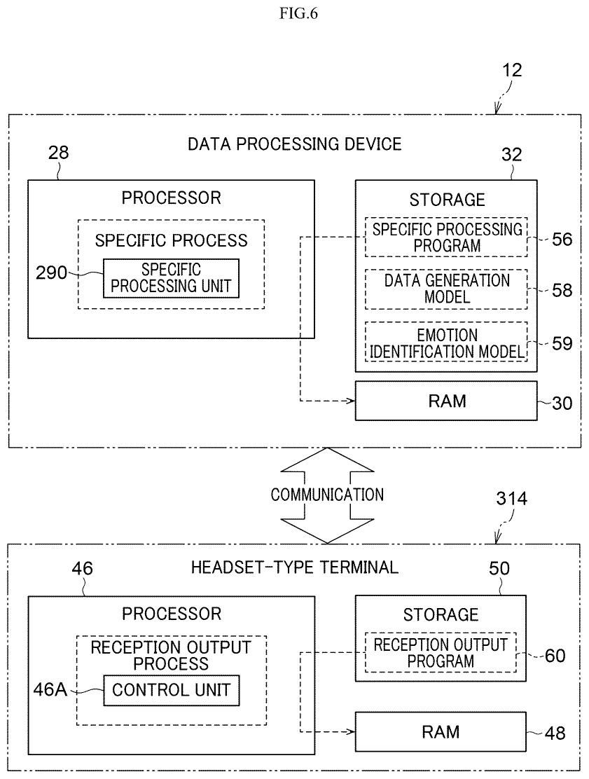

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

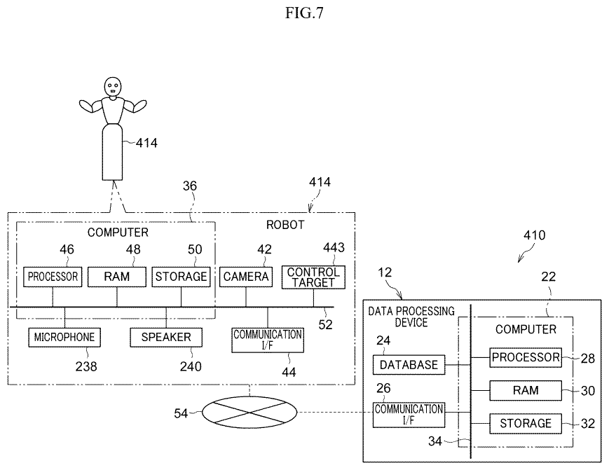

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

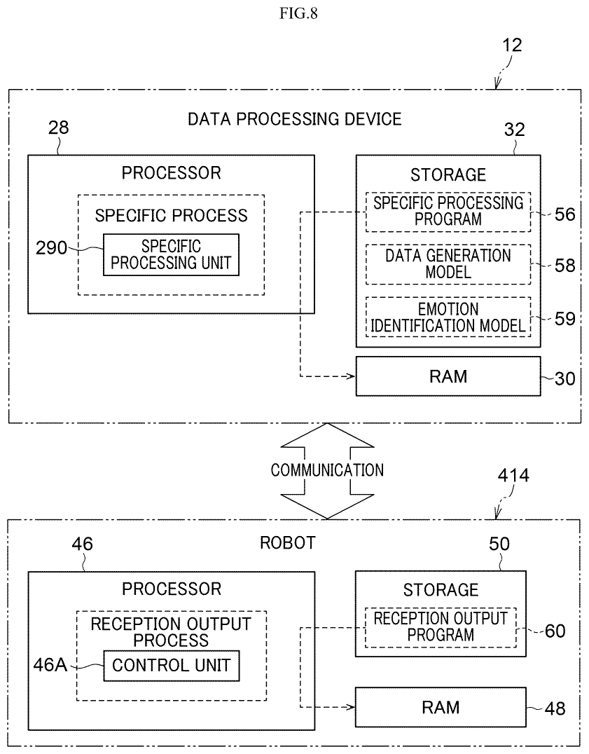

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

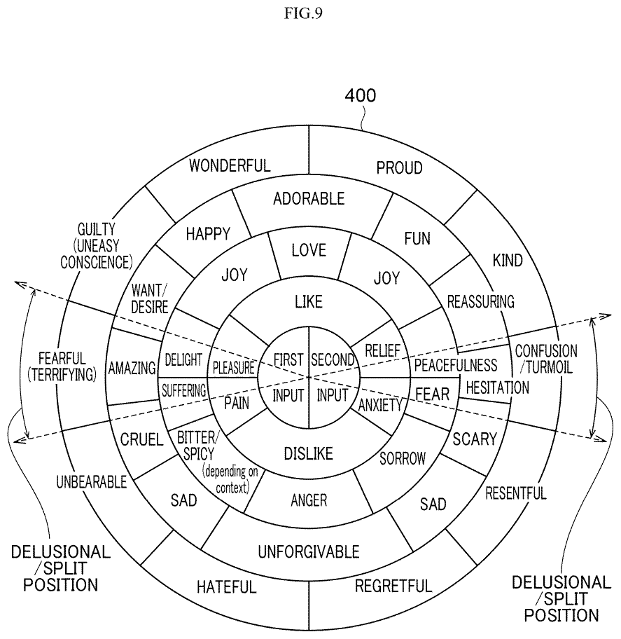

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

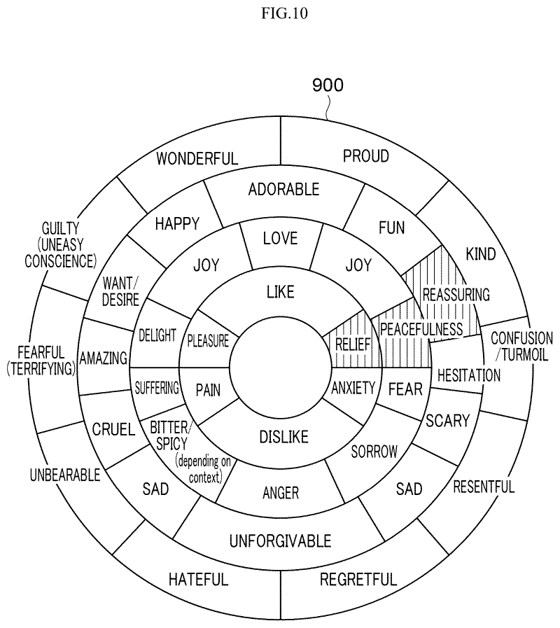

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from a terminal operated by a user, text data including a prompt sentence that expresses a memory or an emotion of the user, the text data being transmitted as character information via a communication network; and
perform preprocessing on the text data by executing natural language processing on an information processing apparatus, the preprocessing including tokenizing the text data and removing unnecessary characters from the text data to obtain preprocessed text data; and
analyze the preprocessed text data to extract at least an emotion element and a visual element, and generate, on the basis of the preprocessed text data, a generation instruction sentence including a prompt sentence for input to a generative artificial intelligence model; and
transmit, via a communication interface, generation request data including the prompt sentence to the generative artificial intelligence model, and acquire, from the generative artificial intelligence model, extended text that describes in detail the memory or the emotion of the user corresponding to the prompt sentence; and
generate, on the basis of the extended text, an image generation prompt sentence, transmit the image generation prompt sentence to an image generation model, acquire visual expression data generated by the image generation model, and convert the extended text and the visual expression data into output data in an output data format; and
transmit the output data to the terminal so that the terminal displays, on a display device, the extended text and the visual expression data; and
store, in a storage device, at least part of the text data, the preprocessed text data, the extended text, and the visual expression data in association with one another, and manage the stored data for reuse or regeneration.

### (Supplementary 2)

The system according to supplementary 1,
wherein the processor is configured to
convert the visual expression data into a plurality of output formats usable as at least one of a background image for a portable information device, an image for a printed medium, an image for an electronic publication, or another type of digital content, and provide, to the terminal or an output apparatus, the visual expression data in a format selected from the plurality of output formats.

### (Supplementary 3)

The system according to supplementary 1,
wherein the processor is configured to
execute, in addition to the natural language processing, emotion analysis processing to calculate a type and an intensity of an emotion contained in the text data as a numerical index, and adjust at least part of the prompt sentence for the generative artificial intelligence model and at least part of the image generation prompt sentence on the basis of the numerical index so as to reflect an emotional nuance of the user in the extended text and in the visual expression data.

### Application Example 1

### (Supplementary 1)

A system comprising a processor,
wherein the processor is configured to
receive description data expressed in natural language as input from a user and analyze the description data by using natural language processing to extract feature information including emotional information and visual information,
generate generation instruction information by constructing a prompt sentence for input to a generative artificial intelligence model on the basis of the feature information and combining the prompt sentence with generation parameters including image generation conditions,
execute an image generation process by using the generation instruction information so as to cause the generative artificial intelligence model to generate image data as a visual representation corresponding to the description data and to obtain the image data,
perform conversion processing on the image data in accordance with a type of display apparatus and a virtual reality display mode so as to convert the image data into an output format including a two-dimensional display format or a virtual reality experience format, and transmit the image data converted into the output format to a display apparatus including a head-mounted display so as to present the image data to the user as an immersive virtual reality experience.

### (Supplementary 2)

The system according to supplementary 1,
wherein the processor is configured to
convert the image data into a resolution and an aspect ratio suitable for still-image display on a display unit of a portable information terminal and into a format suitable for binocular parallax display and background display in a virtual space on the head-mounted display.

### (Supplementary 3)

The system according to supplementary 1,
wherein the processor is configured to
identify a type and an intensity of emotion from the description data by using an emotion analysis algorithm, and to add style information and atmosphere information reflecting the type and the intensity of the emotion to the prompt sentence and the generation parameters so as to cause the visual representation to reflect the type and the intensity of the emotion.

### Example 2

### (Supplementary 1)

A system comprising a processor,
wherein the processor is configured to
receive text information expressed in a natural language as input information from a user terminal, and store the text information as structured data; and
apply a language analysis technique to the text information to extract visual element information including emotion state information and scene information on the basis of meaning information and context information of phrases in the text information, and generate structured information in which the visual element information is organized by attribute; and
automatically generate prompt sentence information as description text information including outline information of a scene, object information, time-zone information, atmosphere information, and expression-style information on the basis of the structured information, and control an amount of text and contents of the prompt sentence information so that the prompt sentence information is suitable as input to a generative AI model for image generation; and
transmit generation request information including the prompt sentence information to the generative AI model for image generation, and acquire visual representation information as image data generated by numerical computation processing executed by the generative AI model; and
apply an image processing technique to the visual representation information to adjust at least one of resolution information, tone information, and sharpness information, and convert the visual representation information into output format information for display or print; and
provide the visual representation information, on the basis of the output format information, as background display information on an electronic display apparatus or as print image information on a print medium.

### (Supplementary 2)

The system according to supplementary 1,
wherein the processor is configured to
regenerate the prompt sentence information on the basis of the visual element information included in the structured information and corrected prompt sentence information input by an editing operation by a user, and use the regenerated prompt sentence information as new input to the generative AI model for image generation to regenerate the visual representation information.

### (Supplementary 3)

The system according to supplementary 1,
wherein the processor is configured to
employ, as the language analysis technique, an emotion analysis process that identifies emotion-type information and emotion-intensity information from the text information, include the emotion-type information and the emotion-intensity information in the structured information, and reflect the emotion-type information and the emotion-intensity information as atmosphere information in the prompt sentence information.

### Application Example 2

### (Supplementary 1)

A system comprising a processor,
wherein the processor is configured to
receive language information as input from a user via a terminal, and analyze the language information by using a natural language processing technique to extract visual element information including object information, environment information, and time information that constitute a scene, and
execute emotion analysis processing on the language information and the visual element information to identify emotion information including an emotion type and an emotion intensity, and
automatically generate a prompt sentence, as an instruction sentence, including constituent elements of the scene, an atmosphere, and an expression style, on the basis of the visual element information and the emotion information, and
input the prompt sentence and generation condition information into a generative artificial intelligence model, and cause the generative artificial intelligence model to generate visual representation data including image data or video data corresponding to the prompt sentence by numerical computation processing, and
configure the visual representation data as at least one of a single image, a continuous story including a plurality of images, and a virtual-space visual content, and perform post-processing to convert a resolution, a viewing angle, and an aspect ratio in accordance with an output format, and
transmit the post-processed visual representation data to an output device including at least one of a display device, a printing device, and a storage device, and provide the post-processed visual representation data as at least one of wallpaper, a printed medium, electronic content, and virtual-reality content.

### (Supplementary 2)

The system according to supplementary 1,
wherein the processor is configured to
generate a plurality of prompt sentences, generate a plurality of types of visual representation data by the generative artificial intelligence model on the basis of the plurality of prompt sentences, structure the plurality of types of visual representation data into list display data for presentation to the user, and, in response to a selection operation by the user, convert only selected visual representation data into a high-resolution output format and provide the selected visual representation data.

### (Supplementary 3)

The system according to supplementary 1,
wherein the processor is configured to
in a case where a generation target of the visual representation data is virtual-space visual content, generate environment configuration information including at least viewpoint position information, line-of-sight direction information, and arrangement information of arrangement targets in a three-dimensional space on the basis of the visual element information and the emotion information, and map the visual representation data into the three-dimensional space in accordance with the environment configuration information, and output the mapped visual representation data as virtual-reality experience content.

What is claimed is:

1. A system comprising:
circuitry configured to:
receive, via a communication interface coupled to a packet-switched network, text data from a terminal device, and execute natural language processing on the text data including tokenization and normalization to generate preprocessed text data;
analyze the preprocessed text data using an emotion classifier to extract an emotion element represented as a numerical index including an emotion type and an emotion intensity score;
apply a syntactic parser to the preprocessed text data to detect nouns, adjectives, and scene-descriptive phrases and construct a visual element data structure describing scene components including spatial relations and object attributes derived from the text data;
generate a generation instruction sentence by inserting the emotion element and the visual element data structure into a prompt template, and transmit generation request data including the generation instruction sentence to a generative neural network model via the communication interface;
receive, from the generative neural network model, extended text that describes in detail content corresponding to the text data, generate an image generation prompt sentence from the extended text and the visual element data structure, and transmit the image generation prompt sentence to an image generation model via the communication interface;
receive visual expression data generated by the image generation model, and apply image processing to the visual expression data to adjust at least one of resolution, tone, and sharpness; and
convert the extended text and the visual expression data into output data in one or more output data formats, transmit the output data to the terminal device via the communication interface, and store the text data, the preprocessed text data, the extended text, and the visual expression data in a storage device in association with one another for reuse or regeneration.

2. The system according to claim 1, wherein the circuitry is configured to adjust at least a portion of the generation instruction sentence and at least a portion of the image generation prompt sentence based on the emotion intensity score of the emotion element, such that the extended text and the visual expression data reflect an emotional nuance of the user.

3. The system according to claim 2, wherein the circuitry is configured to select a prompt template variant from among a plurality of predefined prompt templates based on the emotion type, and construct the generation instruction sentence using the selected template variant to steer the generative neural network model toward output consistent with the emotion type.

4. The system according to claim 3, wherein the circuitry is configured to receive correction information from the terminal device specifying at least one of a modified emotion type, a modified scene element, or a modified output style, regenerate the image generation prompt sentence based on the correction information and the visual element data structure stored in the storage device, and transmit a regeneration request to the image generation model.

5. The system according to claim 4, wherein the circuitry is configured to store the generation instruction sentence, the image generation prompt sentence, and associated generation parameters indexed by a session identifier and a timestamp, such that a prior generation state is recoverable for later regeneration without re-executing the natural language processing pipeline.

6. The system according to claim 1, wherein the circuitry is configured to convert the visual expression data into a plurality of output formats including at least a two-dimensional display format suitable for a portable information device and a virtual reality experience format suitable for a head-mounted display, and transmit the visual expression data in a format selected based on a display capability of the terminal device.

7. The system according to claim 6, wherein the circuitry is configured to receive description data in natural language from the terminal device, apply a natural language processing algorithm to extract feature information including emotional information and visual information, and combine the feature information with image generation conditions as generation parameters in the generation instruction sentence.

8. The system according to claim 7, wherein the circuitry is configured to apply conversion processing to the visual expression data in accordance with a type of display apparatus and a virtual reality display mode, and transmit the converted visual expression data to a head-mounted display device for presentation as an immersive virtual reality experience.

9. The system according to claim 8, wherein the circuitry is configured to apply resolution adjustment processing, tone correction processing, and sharpness adjustment processing to the visual expression data using learned parameters derived from training data, and output visual expression data in an output format information suitable for at least one of electronic display and print.

10. The system according to claim 1, wherein the circuitry is configured to apply structured information generation processing to the visual element data structure to organize the visual element data structure by attribute into structured information including at least outline information of a scene, object information, time-zone information, atmosphere information, and expression-style information, and generate the image generation prompt sentence from the structured information.

11. The system according to claim 10, wherein the circuitry is configured to control an amount of text and contents of the image generation prompt sentence such that the image generation prompt sentence satisfies input constraints of the image generation model including a maximum token length and a format specification.

12. The system according to claim 11, wherein the circuitry is configured to compute semantic similarity between the extended text and the original text data, and if the similarity falls below a threshold, regenerate the generation instruction sentence with adjusted parameters and re-invoke the generative neural network model.

13. The system according to claim 1, wherein the circuitry is configured to receive structured data including a plurality of visual element data structures from the storage device, and generate a plurality of image generation prompt sentences corresponding to respective visual element data structures for batch image generation.

14. The system according to claim 1, wherein the circuitry is configured to convert the visual expression data into output formats usable as at least one of a background image for a portable information device, an image for a printed medium, and an image for an electronic publication, and provide the visual expression data in a format selected based on an output apparatus capability specified in a request from the terminal device.

15. The system according to claim 14, wherein the circuitry is configured to encode the visual expression data using a codec optimized for the selected output format, attach metadata including generation parameters and the session identifier, and transmit an output data package to the terminal device via the communication interface.

16. The system according to claim 1, wherein the circuitry is configured to apply an emotion analysis technique to the text data to identify an intensity and a type of emotion as a numerical index prior to generating the generation instruction sentence, and use the numerical index to select generation parameters including color palette constraints and compositional style attributes for the image generation model.

17. The system according to claim 16, wherein the circuitry is configured to store the numerical index and corresponding visual expression data in the storage device indexed by user identifier and session identifier, and use the stored data as training examples to update the emotion classifier.

18. A system comprising:
circuitry configured to:
receive, via a communication interface coupled to a packet-switched network, text data from a terminal device, and execute natural language processing including tokenization and normalization to generate preprocessed text data;
apply an emotion classifier to the preprocessed text data to extract an emotion element including an emotion type and an emotion intensity score, and apply a syntactic parser to extract a visual element data structure describing scene components and object attributes;
generate a generation instruction sentence incorporating the emotion element and the visual element data structure, and transmit generation request data including the generation instruction sentence to a generative neural network model;
receive extended text from the generative neural network model, generate an image generation prompt sentence from the extended text and the visual element data structure adjusted based on the emotion intensity score, and transmit the image generation prompt sentence to an image generation model;
receive visual expression data from the image generation model and apply image processing to adjust resolution, tone, and sharpness of the visual expression data; and
convert the extended text and the visual expression data into output data in a plurality of output formats including at least a two-dimensional display format and a virtual reality experience format, transmit the output data to the terminal device, and store the text data, the extended text, and the visual expression data in a storage device in association with one another indexed by a session identifier.

19. The system according to claim 18, wherein the circuitry is configured to receive correction information from the terminal device specifying a modified scene element or output style, regenerate the image generation prompt sentence from the visual element data structure stored in the storage device, and transmit a regeneration request to the image generation model without re-executing the natural language processing pipeline.

20. A method comprising:
receiving, via a communication interface coupled to a packet-switched network, text data from a terminal device, and executing natural language processing on the text data including tokenization and normalization to generate preprocessed text data;
analyzing the preprocessed text data using an emotion classifier to extract an emotion element represented as a numerical index including an emotion type and an emotion intensity score;
applying a syntactic parser to the preprocessed text data to detect nouns, adjectives, and scene-descriptive phrases and constructing a visual element data structure describing scene components including spatial relations and object attributes;
generating a generation instruction sentence by inserting the emotion element and the visual element data structure into a prompt template, and transmitting generation request data including the generation instruction sentence to a generative neural network model via the communication interface;
receiving, from the generative neural network model, extended text that describes in detail content corresponding to the text data, generating an image generation prompt sentence from the extended text and the visual element data structure, and transmitting the image generation prompt sentence to an image generation model via the communication interface;
receiving visual expression data generated by the image generation model, and applying image processing to the visual expression data to adjust at least one of resolution, tone, and sharpness; and
converting the extended text and the visual expression data into output data in one or more output data formats, transmitting the output data to the terminal device via the communication interface, and storing the text data, the preprocessed text data, the extended text, and the visual expression data in a storage device in association with one another for reuse or regeneration.
